(19) United States
(12) Patent Application Publication
(10) Pub. No.: US 2009/0228817 A1
(43) Pub. Date: Sep. 10, 2009

(54) SYSTEMS AND METHODS FOR DISPLAYING A SEARCH RESULT

(76) Inventors: Randy Adams, Menlo Park, CA (US); Joe E. Rouvier, Sunnyvale, CA (US)

Correspondence Address: JONES DAY, 222 EAST 41ST ST, NEW YORK, NY, 10017, US

(21) Appl. No.: 12/045,696

(22) Filed: Mar. 10, 2008

(51) Int. Cl. G06F 3/048; G06F 17/30

(52) U.S. Cl. 715/767; 707/3; 707/E17.016

(57) ABSTRACT

Systems and methods for displaying a search result are provided in which a submitted search query is received from a search requester. Responsive to the search query, search results relevant to the submitted search query are retrieved from a document index, where each respective search result in at least a portion of the search results corresponds to a document in a plurality of documents. An annotated static graphic representation of a search result in the search results is displayed. The annotated static graphic representation is constructed by using a stored word map for a static graphic representation to identify each area in the static graphic representation that is occupied by a word in the submitted search query and using this information to highlight each area in the static graphic representation that is occupied by a word in the submitted search query, thereby forming the annotated static graphic representation.

### 1. FIELD OF THE INVENTION

The present application relates generally to information search and retrieval. More specifically, systems and methods are disclosed for displaying search results requested by a search requester.

### 2. BACKGROUND

The use of conventional search engines to identify relevant documents requires significant concentration on the part of the user. Search results are typically in the format of between 10 and 100 words extracted from each web page that is deemed by the conventional search engine to be relevant to a search query. Thus, to find the most relevant results to a given search query, a searcher must read many of these 10 to 100 word web page extracts.

Given the above background, what is needed in the art are improved systems and methods for displaying the hits from searches of document repositories.

### 3. SUMMARY

The present application addresses the deficiencies present in the known art. One aspect of the present invention provides systems and methods for displaying a search result in which a submitted search query is received from a search requester. Responsive to the search query, search results relevant to the submitted search query are retrieved from a document index, where each respective search result in at least a portion of the search results corresponds to a document in a plurality of documents. An annotated static graphic representation of a search result in the search results is displayed. The annotated static graphic representation is constructed by using a stored word map for a static graphic representation to identify each area in the static graphic representation that is occupied by a word in the submitted search query and using this information to highlight each area in the static graphic representation that is occupied by a word in the submitted search query, thereby forming the annotated static graphic representation.

One aspect of the present disclosure provides a method for displaying a search result in which a submitted search query is received from a search requester and a plurality of search results relevant to the submitted search query are obtained from a document index or one or more vertical collections. Each respective search result in at least a portion of the plurality of search results corresponds to a document in a plurality of documents. A first annotated static graphic representation of a first search result in the plurality of search results is displayed. In some embodiments, the first annotated static graphic representation is constructed by (i) using a stored word map for a first static graphic representation of a document in the plurality of documents to identify each area in the first static graphic representation that is occupied by a word in the submitted search query and (ii) highlighting each area in the first static graphic representation that is occupied by a word in the submitted search query thereby forming the first annotated static graphic representation.

In some embodiments, the displaying step displays the first annotated static graphic representation in a center position of a graphic output device and a second annotated static graphic representation of a second search result in the plurality of search results is displayed in a first off-center position of the graphic output device, where the second annotated static graphic representation is displayed rotated about a first axis of rotation that lies between the center position and the first off-center position of the graphic output device, and where the second annotated static graphic representation is constructed by (i) using a stored word map for a second static graphic representation of a document in the plurality of documents to identify each area in the second static graphic representation that is occupied by a word in the submitted search query and (ii) highlighting each area in the second static graphic representation that is occupied by a word in the submitted search query thereby forming the second annotated graphic representation.

In some embodiments, the method further comprises, responsive to a selection of the second annotated static graphic representation in the first off-center position, shifting the first annotated static graphic representation to a second off-center position of the graphic output device, thereby causing the first annotated static graphic representation to be displayed at the second off-center position rotated about a second axis of rotation that lies between the center position and the second off-center position of the graphic output device. Furthermore, as part of this action, the second annotated static graphic representation is shifted to the center position of the graphic output device, thereby causing the second annotated static graphic representation to be displayed at the center position in a manner that is no longer rotated about the first axis of rotation. Furthermore, as part of this action, a third annotated static graphic representation of a third search result in the plurality of search results is displayed in the first off-center position of the graphic output device, where the third annotated static graphic representation is displayed rotated about the first axis of rotation.

In some embodiments, the method further comprises, responsive to a selection of the first annotated static graphic representation in the second off-center position, shifting the first annotated static graphic representation to the center position of the graphic output device, thereby causing the first annotated static graphic representation to be displayed at the center position in a manner that is no longer rotated about the second axis of rotation, and shifting the second annotated static graphic representation to the first off-center position, thereby causing the second annotated static graphic representation to be displayed at the first off-center position in a manner that is rotated about the first axis of rotation. In some embodiments, the method further comprises removing the third annotated static graphic representation from the first off-center position.

In some embodiments, the method further comprises, responsive to a selection of the first annotated static graphic representation in the center position of the graphic output device, the step of enlarging a size of the first annotated static graphic representation. In some embodiments, responsive to a selection of a portion of the graphic output device outside of the first annotated static graphic representation when the first annotated static graphic representation is in an enlarged state, the size of the first annotated static graphic representation is reduced to an original size.

In some embodiments, responsive to a selection of the first annotated static graphic representation, the method further comprises retrieving a web page impression from the source document corresponding to the first annotated static graphic representation and replacing the first annotated static graphic representation with the web page impression. In some embodiments the method further comprises, responsive to a selection of the first annotated static graphic representation, flipping the first annotated static graphic representation from a first side to a reverse side so that the reverse side of the first annotated static graphic representation is shown. In some embodiments, the reverse side of the first annotated static graphic representation contains information about the first annotated static graphic representation.

In some embodiments, the method further comprises providing a first toggle bar on the graphic output device such that (i) when the search requester pulls the first toggle bar in a first direction, annotated static graphic representations of search results in the plurality of search results shift from the first off-center position to the center position, and from the center position to a second off-center position responsive to the pull in the first direction and (ii) when the search requester pulls the first toggle bar in a second direction, annotated static graphic representations of search results in the plurality of search results shift from the second off-center position to the center position, and from the center position to the first off-center position responsive to the pull in the second direction.

In some embodiments, the method further comprises embedding an advertisement into the plurality of search results as a static graphic representation, where, when the search requester pulls the first toggle bar in the first direction or the second direction, an advertisement is displayed in the center position. In some embodiments, the method further comprises providing a first toggle bar on the graphic output device, providing a second toggle bar on the graphic output device, displaying a list comprising a text representation of one or more search results in the plurality of search results, such that (i) when the search requester pulls the first toggle bar or the second toggle bar in a first direction, annotated static graphic representations of search results in the plurality of search results shift from the first off-center position to the center position, and from the center position to a second off-center position, and the list scrolls in a first direction, responsive to the pull in the first direction and (ii) when the search requester pulls the first toggle bar or the second toggle bar in a second direction, annotated static graphic representations of search results in the plurality of search results shift from the second off-center position to the center position, and from the center position to the first off-center position, and the list scrolls in a second direction, responsive to the pull in the second direction.

In some embodiments, the method further comprises, responsive to a selection and drag on the first annotated static graphic representation in the direction of a predetermined position on the graphic output device, storing a copy of the first annotated static graphic representation on a client device. In some embodiments, the method further comprises embedding an advertisement into the plurality of search results as a static graphic representation. In some embodiments, the static graphic representation of a document corresponding to the respective search result is a graphic representation of an entire web page at a time before the submitted search query was received.

In some embodiments, any of the above-described displaying steps further comprises displaying a reflection of the first annotated static graphic representation below the first annotated static graphic representation. In some embodiments, the method further comprises embedding an interactive widget as a search result in the plurality of search results and displaying an annotated static graphic representation of one or more search results in said plurality of search results, other than the first annotated static representation, in a plurality of off-center positions of the graphic output device, where a search result in said one or more search results is the interactive widget, and where each annotated static graphic representation of one or more search results in said plurality of search results in the plurality of off-center positions of the graphic output device are rotated about a first axis of rotation that lies between the center position and the plurality of off-center positions of the graphic output device.

One aspect of the present disclosure provides a computer program product for use in conjunction with a computer system, the computer program product comprising a computer readable storage medium and a computer program mechanism embedded therein. The computer program mechanism comprises instructions for carrying out any of the method disclosed herein.

One aspect of the present disclosure provides a computer program product for use in conjunction with a computer system, the computer program product comprising a computer readable storage medium and a computer program mechanism embedded therein. The computer program mechanism comprises instructions for receiving a submitted search query from a search requester and instructions for obtaining a plurality of search results relevant to the submitted search query from a document index or one or more vertical collection, where each respective search result in at least a portion of the plurality of search results corresponds to a document in a plurality of documents. The computer program product further comprises instructions for displaying a first annotated static graphic representation of a first search result in said plurality of search results, where the first annotated static graphic representation is constructed by (i) using a stored word map for a first static graphic representation of a document in the plurality of documents to identify each area in the first static graphic representation that is occupied by a word in the submitted search query and (ii) highlighting each area in the first static graphic representation that is occupied by a word in the submitted search query thereby forming the first annotated static graphic representation.

Another aspect of the present invention provides a computer comprising a main memory, a processor, and one or more programs, stored in the main memory and executed by the processor, the one or more programs collectively including instructions for carrying out any of the methods disclosed herein.

Another aspect of the present invention provides a computer comprising a main memory, a processor, and one or more programs, stored in the main memory and executed by the processor, the one or more programs collectively including instructions for receiving a submitted search query from a search requester and instructions for obtaining a plurality of search results relevant to the submitted search query from a document index or one or more vertical collection, where each respective search result in at least a portion of the plurality of search results corresponds to a document in a plurality of documents. The one or more programs collectively further include instructions for displaying a first annotated static graphic representation of a first search result in said plurality of search results, where the first annotated static graphic representation is constructed by (i) using a stored word map for a first static graphic representation of a document in the plurality of documents to identify each area in the first static graphic representation that is occupied by a word in the submitted search query and (ii) highlighting each area in the first static graphic representation that is occupied by a word in the submitted search query thereby forming the first annotated static graphic representation.

### 4. BRIEF DESCRIPTION OF THE DRAWINGS

FIG. 1 illustrates a system in accordance with an aspect of the present disclosure.

FIG. 2 illustrates a search query prompt for searching one or more document repositories in accordance with an embodiment of the present disclosure.

FIG. 3 illustrates a search query prompt in accordance with an embodiment of the present disclosure, in which a partial search query has been entered, and responsive thereto, suggested vertical categories have been provided.

FIG. 4 illustrates a search query prompt in accordance with an embodiment of the present disclosure, in which a more complete search query has been entered relative to FIG. 3, and responsive thereto, updated suggested vertical categories have been provided.

FIG. 5 illustrates the display of a first annotated static graphic representation from the search query of FIG. 4 in a center position of a graphic output device and displaying a second annotated static graphic representation from the search results for the search query of FIG. 4 in a first off-center position of the graphic output device, where the second annotated static graphic representation is displayed rotated about a first axis of rotation that lies between the center position and the first off-center position, in accordance with an aspect of the present disclosure.

FIG. 6 illustrates how, responsive to a selection of the second annotated static graphic representation in the first off-center position of FIG. 5, (i) the first annotated static graphic representation is shifted to a second off-center position (to the left of the center position), thereby causing the first annotated static graphic representation to be displayed at the second off-center position rotated about a second axis of rotation that lies between the center position and the second off-center position, (ii) the second annotated static graphic representation is shifted to the center position, thereby causing the second annotated static graphic representation to be displayed at the center position in a manner that is no longer rotated about the first axis of rotation, and (iii) a third annotated static graphic representation is displayed in the first off-center position (to the right of the center position), where the third static annotated graphic representation is displayed rotated about the first axis of rotation that lies between the center position and the first off-center position in accordance with an aspect of the present disclosure.

FIG. 7 further illustrates how, relative to FIG. 6, annotated static graphic representations can be shifted in accordance with an aspect of the present disclosure.

FIG. 8 illustrates how the search term “hydroxyl” is highlighted (shown by ovals) in each of the displayed annotated static graphic representations in the search result responsive to the search term “hydroxyl” in accordance with an aspect of the present disclosure.

FIG. 9 illustrates how the search terms “hydroxyl” and “chemical” are highlighted in each of the displayed annotated static graphic representations in the search result responsive to the search terms “hydroxyl” and “chemical” in accordance with an aspect of the present disclosure.

FIG. 10 illustrates how the search term “restaurant” is highlighted in each of the displayed annotated static graphic representations in the search result responsive to the search term “hydroxyl” in accordance with an aspect of the present disclosure.

FIG. 11 illustrates how text-based representations of search hits can be provided in conjunction with the annotated static graphic representations of search hits in accordance with an embodiment of the present invention.

FIG. 12 illustrates how a common toggle bar can be used to jointly scroll through text-based representations of search hits and annotated static graphic representations of search hits in accordance with an embodiment of the present invention.

FIG. 13 illustrates the architecture of a vertical index in accordance with one embodiment of the present disclosure.

FIG. 14 illustrates an exemplary method in accordance with an embodiment of the present disclosure.

Like reference numerals refer to corresponding parts throughout the several views of the drawings.

### 5. DETAILED DESCRIPTION

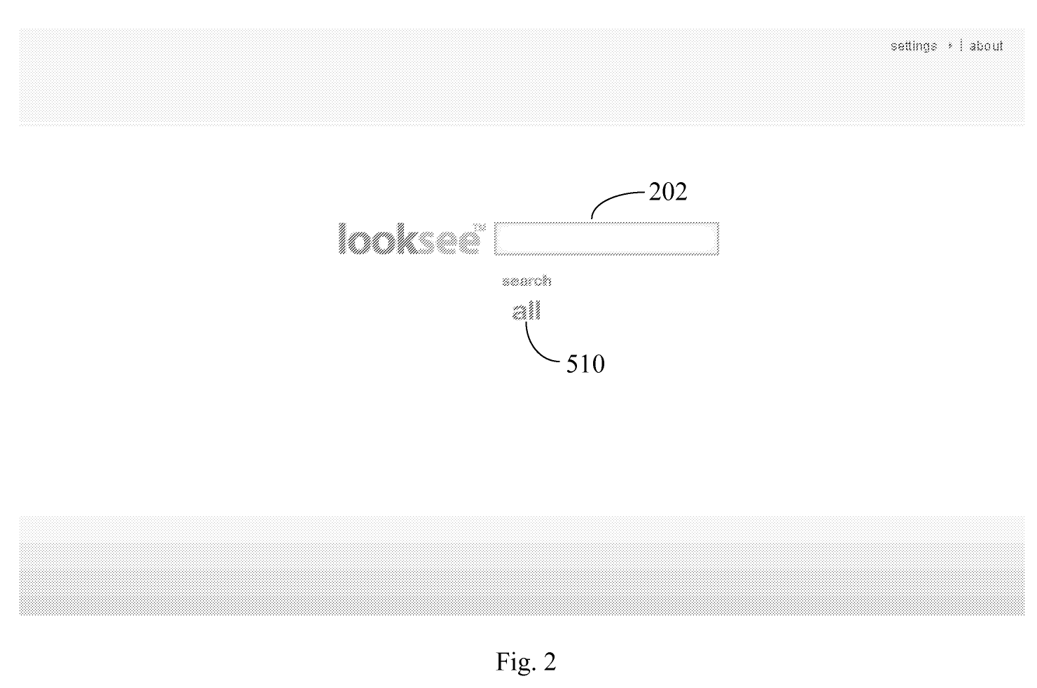

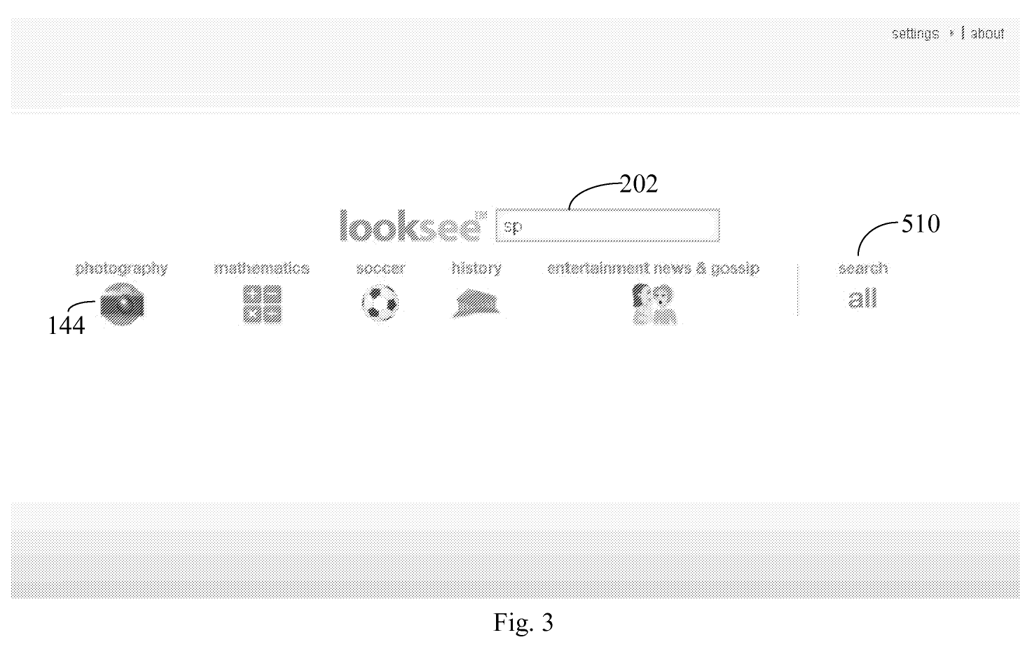

The present disclosure details novel advances over known search engines. A search query or a partial search query is submitted to a search engine. Upon receiving the search query or partial search query, the search engine optionally identifies vertical collections in an optional vertical collection index that are relevant to the search query. In embodiments that make use of vertical collections, the names of the candidate vertical collections are then returned to a client computer where they are displayed. For example, consider FIG. 2, which comprises a prompt 202 for a search query. Turning to FIG. 3, a search requester enters the partial search query “sp” into prompt 202. In response, the search engine returns five vertical collections 144 that match the partial search query: photography, mathematics, soccer, history, and entertainment news & gossip. The user can select one of the optional vertical collections 144 from FIG. 3 and proceed to search the vertical collection 144 with the original search expression or new search expressions. Alternatively, the user can continue typing in a search query. Alternatively still, the user can press the “Search All” button 510 and search a document index that represents the entire Internet or intranet with the search expression “sp.” In some embodiments, there are no vertical collections offered and the user simply presses a predetermined key, such as carriage return, or the search all button, or some logical equivalent (e.g., a predetermined mouse key click or combination of clicks) and a document index that represents the entire Internet, intranet, or some other distributed set of documents is searched. As used herein, a document index represents the entire Internet when documents were pulled from more than 100 locations, more than 1000 locations, more than 100,000 locations, more than one million, or more than one billion locations on the Internet, an intranet, or some set of documents distributed amongst a plurality of computers (e.g., more than 10, more than 100 computers).

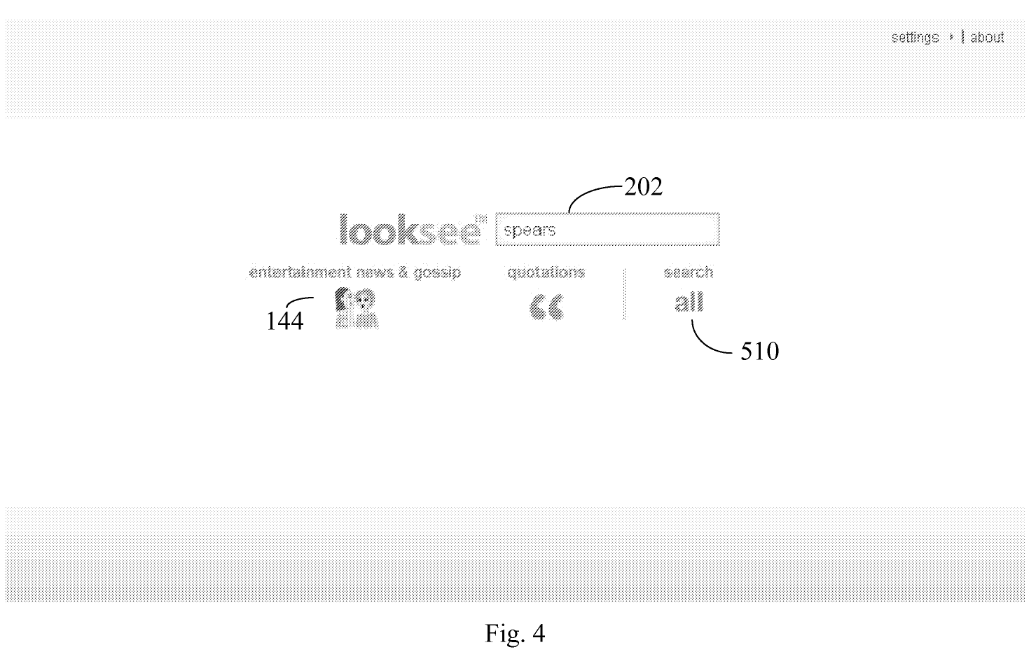

Turning to FIG. 4, the search requester chooses to complete the expression “sp” so that it reads “spears.” In response, the search engine optionally returns two vertical collections that match the updated search query: entertainment news & gossip as well as quotations. In embodiments that provide vertical collections, the user can select one of the vertical collections 144 from FIG. 4 and proceed to search the vertical collection with the original search expression or new search expressions. Alternatively, the user can continue typing in a search query. Alternatively still, the user can press the “Search All” button 510 and search a document index that represents the entire Internet or intranet with the search expression “spears.” As stated before, in some embodiments, no vertical collections are used and the user simply has the option to search a predetermined document index.

As set forth above, in some embodiments, vertical collections are used rather than an index that represents the entire Internet. A “vertical collection” comprises a set of documents (e.g., URLs, websites, etc.) that relate to a common category. For example, web pages pertaining to sailboats constitute a “sailboat” vertical collection. Web pages pertaining to car racing constitute a “car racing” vertical collection. In some embodiments, users search a vertical collection so that only documents relevant to the category or categories represented by the vertical collection are returned to the user. Advantageously, the present disclosure provides systems and methods for helping a searcher identify the appropriate vertical collection to search. In some embodiments, users search a document index representative of the entire Internet or intranet rather than a vertical collection. More information on vertical collection suggestion technology that can be used in the systems and methods described herein is disclosed in United States Patent Publication No. 20070244863 entitled “Systems and Methods for Performing Searches within Vertical Domains” and United States Patent Publication No. 20070244862 entitled “Systems and Methods for Ranking Vertical Domains,” each of which is hereby incorporated by reference herein in its entirety.

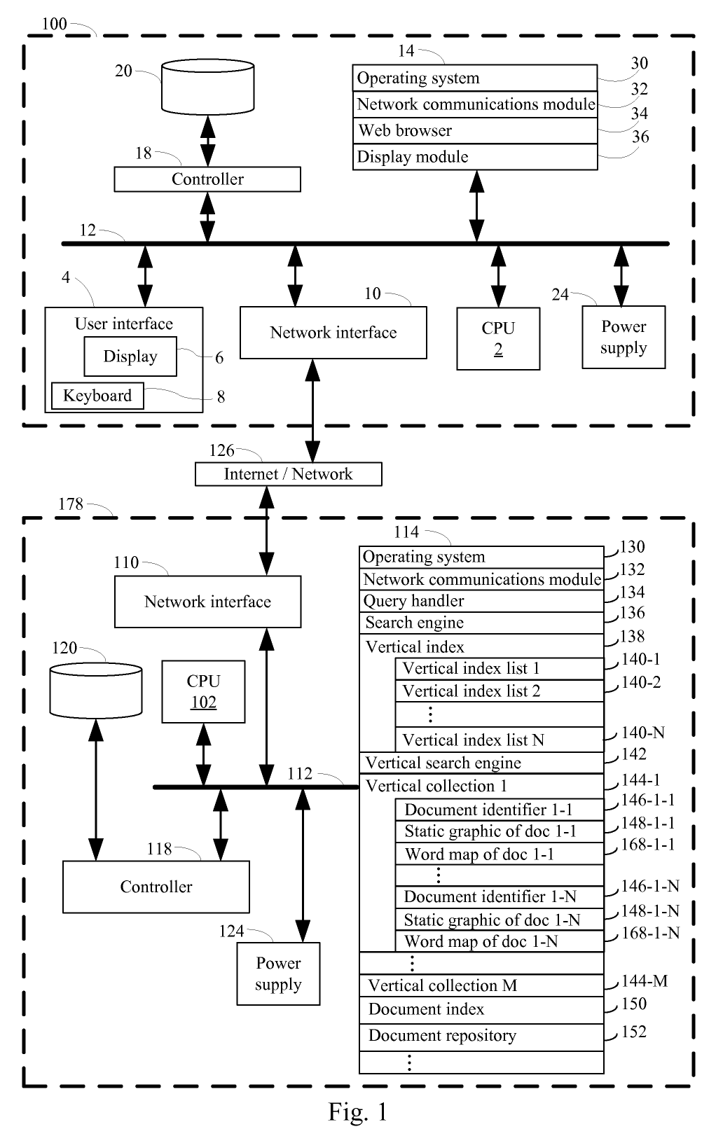

Now that an overview of the novel search query process and its advantages have been provided, a more detailed description of a system in accordance with the present application is described in conjunction with FIG. 1. FIG. 1 illustrates a search engine server 178 in accordance with one embodiment of the present disclosure. In some embodiments, search engine server 178 is implemented using one or more (not shown) computer systems. It will be appreciated by those of skill in the art that search engines designed to process large volumes of search queries, such as search engine server 178, may use complicated computer architectures not shown in FIG. 1. For instance, a front end set of servers may be used to receive and distribute search queries from numerous client 100s among a set of back-end servers that actually process the search queries. In such a system, vertical search engine server 178 as shown in FIG. 1 would be one such back-end server.

Search engine 178 will typically have one or more processing units (CPUs) 102, a network or other communications interface 110, a memory 114, one or more magnetic disk storage devices 120 accessed by one or more controllers 118, one or more communication busses 112 for interconnecting the aforementioned components, and a power supply 124 for powering the aforementioned components. Data in memory 114 can be seamlessly shared with non-volatile memory 120 using known computing techniques such as caching. Memory 114 and/or memory 120 can include mass storage that is remotely located with respect to the central processing unit(s) 102. In other words, some data stored in memory 114 and/or memory 120 may in fact be hosted on computers that are external to vertical search engine 178 but that can be electronically accessed by vertical search engine over an Internet, intranet, or other form of network or electronic cable (illustrated as element 126 in FIG. 1) using network interface 110.

Memory 114 preferably stores:
an operating system 130 that includes procedures for handling various basic system services and for performing hardware dependent tasks;
a network communication module 132 that is used for connecting search engine 178 to various client computers such as client computers 100 (FIG. 1) and possibly to other servers or computers via one or more communication networks, such as the Internet, other wide area networks, local area networks (e.g., a local wireless network can connect the client computers 100 to vertical search engine 178), metropolitan area networks, and so on;
a query handler 134 for receiving a search query from a client computer 100;
a search engine 136 for searching either one or more selected optional vertical collection 144 or a document index 150, where document index 150 can, for example, represent the entire Internet or an intranet, for documents related to a search query and for forming a group of ranked documents that are related to the search query;
an optional vertical index 138 comprising a plurality of vertical indexes 140, where each vertical index is an index of a corresponding vertical collection 144;
an optional vertical search engine 142, for searching optional vertical index 138 for one or more vertical index lists 140 that are relevant to a given search query;
an optional plurality of vertical collections 144, each optional vertical collection 144 comprising a plurality of document identifiers 146 and, for each respective document identifier 146, a static graphic representation 148 of the source URL for the document represented by the respective document identifier 146 as well as a word map 168 for the static graphic representation that comprises, for each respective word in a plurality of words in the document, each area in the static graphic representation that is occupied by the respective word;
a document index 150 comprising a list of terms, a document identifier uniquely identifying each document associated with terms in the list of terms, and the sources of these documents; and
a document repository 152 comprising a source URL or a reference to a source URL for each document in the document repository and (ii) a static graphic representation of the source URL for each document in the document repository.

Search engine 178 is connected via Internet/network 122 to one or more client devices. FIG. 1 illustrates the connection to only one such client device 100. However, in practice, search engine 178 can be connected to 10 or more of the client devices 100, 100 or more of the client devices 100, more typically 1000 or more of the client devices 100, more typically still 10,000 or more of the client devices 100, and more typically still, 100,000 or more of the client devices 100. In typical embodiments, a client device 100 comprises:
one or more processing units (CPUs) 2;
a network or other communications interface 10;
a memory 14;
optionally, one or more magnetic disk storage devices 20 accessed by one or more optional controllers 18;
a user interface 4, the user interface 4 including a display 6 and a keyboard or other input device 8;
one or more communication busses 12 for interconnecting the aforementioned components; and
a power supply 24 for powering the aforementioned components.

In some embodiments, data in memory 14 can be seamlessly shared with non-volatile memory 20 using known computing techniques such as caching. In some embodiments the client device 100 does not have a magnetic disk storage device. For instance, in some embodiments, the client device 100 is a portable handheld computing device and network interface 10 communicates with Internet/network 126 by wireless means.

Memory 14 preferably stores:
an operating system 30 that includes procedures for handling various basic system services and for performing hardware dependent tasks;
a network communication module 32 that is used for connecting client device 100 to search engine 178;
a web browser 34 for receiving a search query from client computer 100; and
a display module 36 for instructing the web browser 34 on how to display search results relevant to a submitted search query.

In some embodiments, a document index 150 is constructed by scanning documents on the Internet and/or intranet for relevant search terms. An exemplary document index 150 is illustrated below:

| Term | Document Identifier |
|---|---|
| term 1 | docID₁ₐ, . . . , docID₁ₓ |
| term 2 | docID₂ₐ, . . . , docID₂ₓ |
| term 3 | docID₃ₐ, . . . , docID₃ₓ |
| . | |
| . | |
| . | |
| term N | docID_{Na}, . . . , docID_{Nx} |

In some embodiments, the document index 150 is constructed by conventional indexing techniques. Exemplary indexing techniques are disclosed in, for example, United States Patent publication 20060031195, which is hereby incorporated by reference herein in its entirety. By way of illustration, in some embodiments, a given term may be associated with a particular document when the term appears more than a threshold number of times in the document. In some embodiments, a given term may be associated with a particular document when the term achieves more than a threshold score. Criteria that can be used to score a document relative to a candidate term include, but are not limited to, (i) a number of times the candidate term appears in an upper portion of the document, (ii) a normalized average position of the candidate term within the document, (iii) a number of characters in the candidate term, and/or (iv) a number of times the document is referenced by other documents. High scoring documents are associated with the term. In preferred embodiments, document index 150 stores the list of terms, a document identifier uniquely identifying each document associated with terms in the list of terms, and, optionally, the scores of these documents. In some embodiments, the document identifier uniquely identifying each document is a uniform resource location (URL) or a value or number that represents a uniform resource location (URL). Those of skill in the art will appreciate that there are numerous methods for associating terms with documents in order to build document index 150 and all such methods can be used to construct document index 150 of the present invention.

There is no limit to the number of terms that may be present in document index 150. Moreover, there is no limit on the number of documents that can be associated with each term in document index 150. For example, in some embodiments, between zero and 100 documents are associated with a search term, between zero and 1000 documents are associated with a search term, between zero and 10,000 documents are associated with a search term, or more than 10,000 documents are associated with a search term within document index 150. Moreover, there is no limit on the number of search terms to which a given document can be associated. For example, in some embodiments, a given document is associated with between zero and 10 search terms, between zero and 100 search terms, between zero and 1000 search terms, between zero and 10,000 search terms, or more than 10,000 search terms.

In the context of this application, documents are understood to be any type of media that can be indexed and retrieved by a search engine, provided that such documents code for a unique web page that is available on the Internet. Thus, in the present invention, there is a one-to-one correspondence between a document and a unique web page available on the Internet. A document may code for one or more web pages as appropriate to its content and type. In the present disclosure, there are many documents indexed. Typically, there are more than one hundred thousand documents, more than one million documents, more than one billion documents, or even more than one trillion documents present in document index 150.

In a preferred embodiment, for each document referenced by document index 150, search engine server 178 stores or can electronically retrieve (i) the source document or a document identifier 146 (document reference) that can be used to retrieve the source document, (ii) a static graphic representation 148 of the source document, and (iii) a word map 168 for the static graphic representation that comprises, for each respective word in a plurality of words in the source document, each area in the static graphic representation that is occupied by the respective word. Of course, some documents reference by document index 150 may not contain words and, consequently, for such documents there will be no word map 168 or the word map 168 will contain no words. In some embodiments, the document identifier 146 is stored in document index 150 while the static graphic representation 148 of the source document and the word map 168 are stored in document repository 152. In some embodiments, the document identifier 146, the static graphic representation 148, and the word map 168 of each source document tracked by search engine server 178 is stored in document index 150. In some embodiments, the document identifier 146, the static graphic representation 148, and the word map 168 of the each source document tracked by search engine server 178 is stored in document repository 152. It will be appreciated that document identifiers 146, static graphic representations 148, and word maps 168 may be stored in any number of different ways, either in the same data structure or in different data structures within search engine server 178 or in computer readable memory or media that is accessible to search engine server 178.

In some embodiments each static graphic representation and each annotated static graphic representation of a document is a bitmapped or pixmapped image of a web page encoded by the code in the corresponding document. As used herein, a bitmap or pixmap is a type of memory organization or image file format used to store digital images. A bitmap is a map of bits, a spatially mapped array of bits. Bitmaps and pixmaps refer to the similar concept of a spatially mapped array of pixels. Raster images in general may be referred to as bitmaps or pixmaps. In some embodiments, the term bitmap implies one bit per pixel, while a pixmap is used for images with multiple bits per pixel. One example of a bitmap is a specific format used in Windows that is usually named with the file extension of .BMP (or .DIB for device-independent bitmap). Besides BMP, other file formats that store literal bitmaps include InterLeaved Bitmap (ILBM), Portable Bitmap (PBM), X Bitmap (XBM), and Wireless Application Protocol Bitmap (WBMP). In addition to such uncompressed formats, as used herein, the term bitmap and pixmap refers to compressed formats. Examples of such bitmap formats include, but are not limited to, formats, such as JPEG, TIFF, PNG, and GIF, to name just a few, in which the bitmap image (as opposed to vector images) is stored in a compressed format. JPEG is usually lossy compression. TIFF is usually either uncompressed, or losslessly Lempel-Ziv-Welch compressed like GIF. PNG uses deflate lossless compression, another Lempel-Ziv variant. More disclosure on bitmap images is found in Foley, 1995, Computer Graphics: Principles and Practice, Addison-Wesley Professional, p. 13, ISBN 0201848406 as well as Pachghare, 2005, Comprehensive Computer Graphics Including C++, Laxmi Publications, p. 93, ISBN 8170081858, each of which is hereby incorporated by reference herein in its entirety.

In typical uncompressed bitmaps, image pixels are generally stored with a color depth of 1, 4, 8, 16, 24, 32, 48, or 64 bits per pixel. Pixels of 8 bits and fewer can represent either grayscale or indexed color. An alpha channel, for transparency, may be stored in a separate bitmap, where it is similar to a greyscale bitmap, or in a fourth channel that, for example, converts 24-bit images to 32 bits per pixel. The bits representing the bitmap pixels may be packed or unpacked (spaced out to byte or word boundaries), depending on the format. Depending on the color depth, a pixel in the picture will occupy at least n/8 bytes, where n is the bit depth since 1 byte equals 8 bits. For an uncompressed, packed within rows, bitmap, such as is stored in Microsoft DIB or BMP file format, or in uncompressed TIFF format, the approximate size for a n-bit-per-pixel (2ⁿ colors) bitmap, in bytes, can be calculated as: size≈width×height×n/8, where height and width are given in pixels. In this formula, header size and color palette size, if any, are not included. Due to effects of row padding to align each row start to a storage unit boundary such as a word, additional bytes may be needed.

As stated above, a word map 168 for the static graphic representation 148 of a document comprises, for each respective word in a plurality of words in the document, each area in the static graphic representation that is occupied by the respective word. Advantageously, in the present invention, this word map is extracted by parsing the code for a unique web page encoded by a document and constructing a static graphic representation for the unique web page. For example, in some embodiments, the code for a unique web page that corresponds to a document is parsed in order to construct the bitmapped or pixmapped image of the web page. During this parsing, each word that is to be rendered in the bitmapped or pixmapped image is identified. Any applicable style sheets, HTML features, or other attributes are fully interpreted during this parsing so that the exact size and location and appearance of each word that is to be rendered in the bitmapped or pixmapped image is known. While such information is required for the bitmapped or pixmapped image it is also advantageously used to construct the word map 168 for the document. The contents of an exemplary word map 168 are shown in the following table:

| | | | | | | Font/ | Feature |
|---|---|---|---|---|---|---|---|
| | Instance | x-coordinate | y-coordinate | x-size | y-size | Point | (e.g., |
| Word | number | (pixels) | (pixels) | (pixels) | (pixels) | Size | attribute) |
| Hello | 1 | 125 | 300 | 10 | 400 | Times | Italic, |
| | | | | | | Roman/ | Underline |
| | | | | | | 12 | |
| | 2 | 497 | 400 | 12 | 400 | Times | Italic, |
| | | | | | | Roman/ | Underline |
| | | | | | | 10 | |
| Goodbye | 1 | 302 | 948 | 100 | 300 | Ariel/9 | Boldface |
| | 2 | 562 | 332 | 73 | 500 | Courier/9 | None |

From the table, it is apparent that a word map will contain information for each of a plurality of words that are encoded in the static graphic representation (e.g., bitmapped or pixmapped web page) corresponding to a document. In an exemplary word map 168, each instance of a word in the static graphic representation is listed along with some indicia of the size and location of the instance of the word in the static graphic representation. In some embodiments, if the size of the area occupied by a word is approximated as a rectangle, then the indicia for the size is a reference corner of the rectangle (e.g., the lower left hand corner, the lower right hand corner, the upper left hand corner, the upper right hand corner of the rectangle in the static graphic representation) coupled with an x-size and a y-size in pixels from the reference corner. In some embodiments, the size of the area occupied by a word is tracked by finding the center of the word map in the static graphic representation and then overlapping a two-geometric object such as a square, rectangle, ellipse or circle that encompasses the word in the word map. The area in the static graphic representation occupied by the word is then deeded to be the size of this two-geometric object. Of course any number of ways could be used to track the location and size of an instance of a word in the static graphic representation in the word map 168 and all such ways are within the scope of the present invention. In some embodiments, the size of the area in the word map 168 is tracked by indicating a starting location and orientation of the word and then using the point size and the font of the word, and any applicable attribute (e.g., underlining, bold-face, italics, etc.) to determine the size of the area occupied by the word in the static graphic representation. In some embodiments, the systems and methods of the present invention track the area occupied by a word in a static graphic representation even in instances where the word wraps from the far right hand side of one line of the static graphic representation to the far left hand side of the next line of the static graphic representation.

In some embodiments, the word map 168 tracks more than ten different words in a corresponding static graphic representation 148 and for each respective word in the more than ten different words, the location and the area in the static graphic representation 148 occupied by each instance of the respective word in the static graphic representation.

Advantageously, the features, such as those identified in the table above, of words in a document that are obtained from the process of rendering the static graphic representation can be used in the construction of the document index. By way of illustration, in some embodiments, a given term may be associated with a particular document based upon not only features such as how many times the term appears in the document, but also the location of the term in the static graphic representation, the size of the area in the static graphic representation occupied by a term, and attributes of the term in the static graphic representation such as italics, underlining, boldfacing, strikethrough, font color, shadow, font, or font size. Many of these features are not easily decipherable from the code for the web page in the document code. For example, in some instances the code for a web page of a document makes use of web style sheets. This is a form of separation of presentation and content for web design in which the markup (e.g., HTML or XHTML) of a webpage contains the page's semantic content and structure, but does not define its visual layout (style). Instead, the style is defined in an external stylesheet file using a language such as CSS or XSL. This design approach is identified as a “separation” because it largely supersedes the antecedent methodology in which a page's markup defined both style and structure. Thus, in many instances, because of the use of style sheets, embedded applets, complex JAVA scripts, and other complexities of code use to construct web pages, it is simply not possible to ascertain the location, size, and other features of a term in a document until the web page encoded by the document has been rendered into a static graphic representation such as a bitmapped or pixmapped image. In some embodiments, the static graphic representation is generated using a web browser for which source code is available, such as Mozilla Firefox, in which an extension is added that extracts features about each word as the browser is rendering a static graphic representation of the web page including where on the static graphic representation 148 the word will be located, the size of the word, and any attributes associated with the word. As used herein, a static graphic representation 148 of a web page can be an image of the rendered web page at a given instant in time or a time averaged representation of the web page over a period of time (e.g., one second or more, ten seconds or more, a minute or more, two minutes or more, etc.). Thus, a static graphic representation fully encompasses dynamic web pages that include applets such as ticker tapes or other dynamic components that cause the representation of the web page to change over time. Any dynamic components in a web page can either be ignored when constructing the word map for the document encoding the web page, averaged over a period of time, or a snapshot of such dynamic components (e.g., snapshots) can be used for the purposes of constructing the static graphic representation of the web page.

In some embodiments of the present application, vertical collections 144 are used. Vertical collections 140 are constructed using documents in document index 150 that pertain to a particular category. For example, one vertical collection 144 may be constructed from documents indexed by document index 150 that pertain to movies, another vertical collection 144 may be constructed from documents indexed by document index 150 that pertain to sports, and so forth. Vertical collections 144 can be constructed, merged, or split in a relatively straightforward manner. In some embodiments, there are hundreds of vertical collections 144 set up in this manner. In some embodiments, there are thousands of vertical collections 144 set up in this manner.

Once the document index 150 has been constructed, it is possible to construct the optional vertical index 138. To accomplish this, in some embodiments, each vertical collection 450 is inverted. In some embodiments, each vertical collection 144 has the form:

Vertical collection (V₁)₁₄₄₋₁

DocId₁₄₆₋₁₋₁
Static Graphic DocId₁₄₈₋₁₋₁
Word Map DocId₁₆₈₋₁₋₁
DocId₁₄₆₋₁₋₂
Static Graphic DocId₁₄₈₋₁₋₂
Word Map DocId₁₆₈₋₁₋₂
.
.
.
DocId_{146-1-P}
Static Graphic DocId_{148-1-P}
Word Map DocId_{168-1-P}

In some embodiments, each DocId in the vertical collection 144 further includes a document quality score. Inversion of each of the vertical collections 144 and the merging of each of these inverted vertical collections leads to an inverted document-vertical index having the following data structure:

Inverted document-vertical index

| Document | Associated vertical |
|---|---|
| identifiers | collections 144 |
| DocId₁₋₁ | Vₐ, . . . , Vₓ |
| DocId₁₋₂ | V_{b}, . . . , V_{y} |
| . | |
| . | |
| . | |
| DocId_{1-P} | V_{c}, . . . , V_{z} |
| DocId₂₋₁ | V_{d}, . . . , Vₐₐ |
| . | |
| . | |
| . | |

Thus, for each given document in document index 150, a list of vertical collections 144 associated with the given document can be obtained by taking the associated vertical collections for the given document from the inverted vertical collection. There can be several vertical collections 144 associated with any given document in this manner. Further, there is no requirement that each document be associated with a unique set of vertical collections 144.

Thus, as seen above, with the inverted document-vertical index, it is now possible to create a vertical index 138 by substituting the document identifiers in document index 150 with the corresponding vertical collections associated with such document identifiers as set forth in the inverted document-vertical index. In one approach, this is done by scanning the document index 150 on a termwise basis, and collecting the set of vertical collections 144 that are associated with the documents that are, themselves, associated with each term as set forth in the inverted document-vertical index. For example, consider a term 1 in the exemplary document index 150 presented above. According to document index 150, term 1 is associated with docID₁ₐ, . . . , docID₁ₓ. Thus, for each respective docIDᵢ in the set docID₁ₐ, . . . , docID₁ₓ, the inverted document-vertical index is consulted to determine which vertical collections 144 are associated with the respective docIDᵢ. Each of these vertical collections 144 are then associated with term 1 in order to construct a vertical index list 140 for term 1. Thus, starting with the entry for term 1 in document index 150,

| | |
|---|---|
| term 1 | docID₁ₐ, . . . , docID₁ₓ |

the set of vertical collections associated with docID₁ₐ, . . . , docID₁ₓ are collected from the inverted document-vertical index in order to construct the vertical index list 140:

| | |
|---|---|
| term 1 | V₁, V₂, . . . , V_{N} |

where each of V₁, V₂, . . . , V_{N} is a vertical collection identifier that points to a unique vertical collection 144. This data structure is a vertical index list 140. As illustrated, a vertical index list 140 is a list of vertical collection identifiers of vertical collections 144 sharing a definable attribute (e.g., “term 1”). If term 1 was “vacation,” than vertical index list 140 contains the identifiers of the vertical collections 144 holding documents containing the word “vacation.” The predicate defining the list, “term 1” in the above example, is referred to as the “head term.”

By considering all the terms in a collection of terms, vertical index 138 is constructed. There may be a large number of terms in the collection of terms. Vertical index 138 comprises vertical index lists 140, along with an efficient process for locating and returning the vertical index list 140 corresponding to a given attribute (search term). For example, a vertical index 138 can be defined containing vertical index lists 140 for all the words appearing in a collection. Vertical index 138 stores, for each given word in the collection, a vertical index list 140 of those vertical collections 144. Each such vertical collection 144 in the vertical index list 140 for the given word holds at least some documents containing the given word.

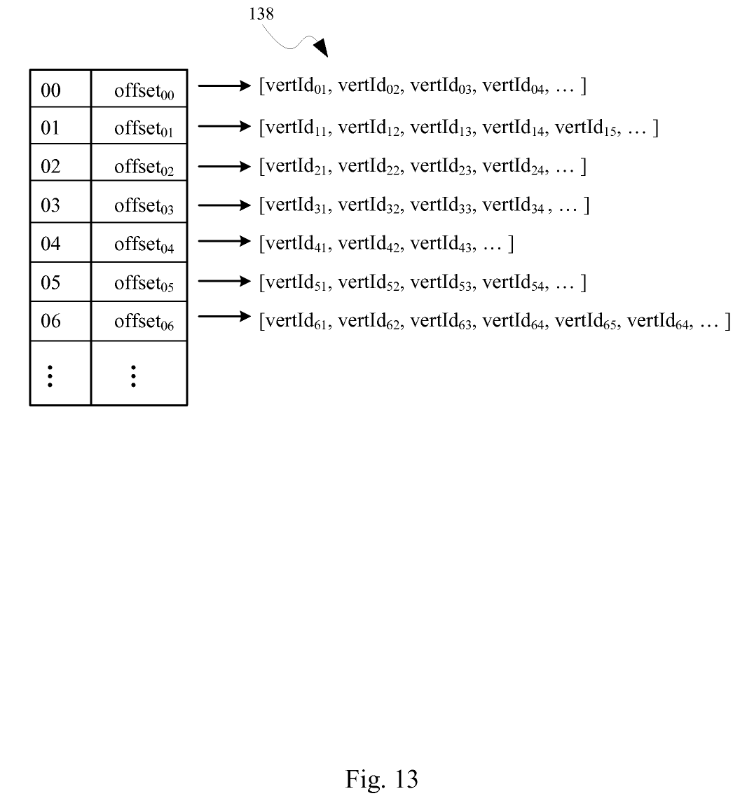

Referring to FIG. 13, a specific structure for vertical index 138 is provided in accordance with one embodiment of the present invention. In this embodiment, vertical index 138 comprises a hash lookup table and a vertical index list storage component. The hash lookup table contains pointers or file offsets that pinpoint the location of an individual vertical index list 140. A hash of a given head term (search term) provides the correct offset to corresponding list of vertical collections 144 that hold documents for the given head term. For example, consider the case in which the head term is “vacation.” The head term is hashed to give, in this example, the offset 03. A table lookup at offset 03 in vertical index 138 gives the list of identifiers {vertId₃₁, vertId₃₂, vertId₃₃, vertId₃₄, . . . } that correspond to the head term “vacation.” Each identifier in the set {vertId₃₁, vertId₃₂, vertId₃₃, vertId₃₄, . . . } corresponds to a vertical collection 144 that contains documents with the “vacation” head term. Continuing to refer to FIG. 13, the vertical index lists are shown as having different lengths because that is the usual case. In some embodiments, a term specific score is associated with each vertical identifier in each vertical index list.

Steps for constructing a vertical index 138 have been detailed above. The vertical index 138 includes, for each respective head term in a collection of head terms, the list of vertical collections 144 having documents that contain the respective head term. To optimize vertical index 138, additional steps are taken in some embodiments to rank each vertical collection 144 referenced in each respective vertical index list 140 so that only the most significant vertical collections 144 are returned for any given search query. Methods for ranking vertical collections are disclosed in United States Patent Publication Number 20070244863 which is hereby incorporated by reference herein in its entirety.

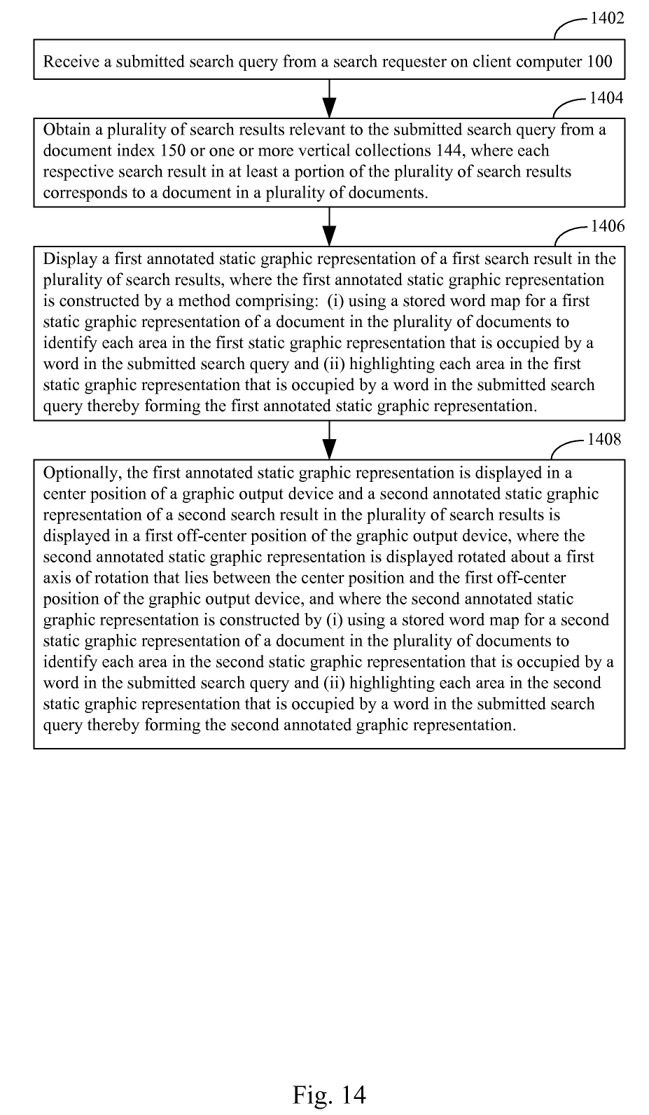

Referring to FIG. 14, exemplary methods in accordance with one aspect of the present disclosure is described. The method details the steps taken to display a search result. Prior to running the method illustrated in FIG. 14, a number of steps are taken by search engine server 178. First a plurality of documents is obtained. This plurality of documents may be 100 or more documents, 1000 or more documents, 10,000 or more documents, a million or more documents, a billion or more documents, or a 100 billion or more documents. Some or all of the documents in the plurality of documents comprises code for a unique web page available on the Internet or an Intranet that corresponds to the respective documents. In some instances the code for a web page of a document in the plurality of documents makes use of web style sheets. In such instances, the page's semantic content and structure is defined by a markup language (e.g., HTML or XHTML) and the page's visual layout (style) is defined in an external stylesheet file using a language such as CSS or XSL. In such instances, the code for the web page is considered to be both the markup language code as well as the external stylesheet file code. Thus, as used herein, the code for a document includes any and all style sheets, embedded applets, complex JAVA scripts, and other complexities of code used to define the web page that is obtained when the code for the document is rendered.

Next, a static graphic representation of a unique web page corresponding to a document in the plurality of documents is rendered. In other words, the code for a unique web page encoded by a document is parsed in order to construct the bitmapped or pixmapped image of the web page. During this parsing, each word that is to be rendered in the bitmapped or pixmapped image is identified. Any applicable style sheets, HTML features, Java code, or any other code or other attributes embedded in the code or referenced by the code in the document is fully interpreted during this parsing so that the bitmapped or pixmapped image of the web page is a true and exact replica of the web page encoded by the document. During this parsing, the exact size and location and appearance of each word that is to be rendered in the bitmapped or pixmapped image is determined. In this way, for each respective word in the plurality of words in the document, each area in the static graphic representation that is occupied by the respective word is determined. While such information is required for the bitmapped or pixmapped image it is also advantageously used to construct the word map 168 for the document.

The static graphic representation 148 and the word map 168 obtained for a document in the plurality of documents is then stored. In some embodiments, these constructs are stored as illustrated in FIG. 1 in the context of vertical collections 144. That is, for each document identifier 146 in a vertical collection 144, the static graphic representation 148 and the word map 168 for the document identifier is associated and stored in a data structure that contains the vertical collection 144. However, there is no requirement that the word map 168 or the static graphic representation 148 for a document be stored in the same data structure, much less in a data structure that contains a vertical collection 144. First, storage of data in this way may be disadvantageous because a given document uniquely represented by a document identifier 146 may be in several different vertical collections 144. Thus, storage of the static graphic representation 148 and the word map 168 of a document along with a document identifier in each of the vertical collections 144 that the document appears in would lead to redundant storage of the static graphic representation 148 and the word map 168 and resultant inefficiency. FIG. 1 is merely used to exemplify the property that there is a word map 168 and a static graphic representation 148 for each document that are constructed, for example, using the methods disclosed above. One of skill in the art, upon the benefit of this disclosure, will appreciate that any of a number of ways may be used to electronically store word maps 168 and static graphic representations 148 of documents so that such constructs can be readily accessed when needed in subsequent steps disclosed below. For example, the word maps 168 and/or static graphic representations 148 can be stored in the document repository or standalone data structures or databases.

The above-described rendering step and the storing are performed for each document in the plurality of documents. In some embodiments, documents in the plurality of documents are rendered in parallel (at the same time) on a single computer or on multiple computers in order to expedite processing of the plurality of documents. In some embodiments, the above-described rendering and storing are repeated for each document in the plurality of documents. However, accomplished, the net result of this action is a word map 168 and a static graphic representation 148 of each document in a plurality of documents available on the Internet, an Intranet, or some other wide area network.

Next, a document index 150 is constructed from the plurality of documents. This document index 150 has the advantage over conventional document indexes because, for each respective document in the document index 150, the static graphic representation 148 and the word map 168 for the respective document is accessible. Thus, when the document index 150 is used to support a search engine, the static graphic representations 148 of the documents that are hits to a search query can be provided rather than a few choice words from the documents as is the case in conventional search engines. For instance, when a submitted search query from a search requester is received, a plurality of search results relevant to the submitted search query is obtained from the document index, where each respective search result in at least a portion of the plurality of search results comprises the static graphic representation of a document in the plurality of documents corresponding to the respective search result created using the above-described rendering process, and a static graphic representation of a search result in the plurality of search results is displayed. Such a stored collection of documents has enormous utility in enhancing web searching as the following steps described in conjunction with FIG. 14 will now illustrate in more detail.

In more detail, in step 1402, a search query is received on client computer 100 from a user. A search query typically comprises a list of one or more keywords, possibly joined by the Boolean operators AND, OR, as well as NOT, and optionally grouped with parentheses or quotes. Examples of search queries include: (i) “Florida discount vacations,” (ii) “The President of the United States,” “(car OR automobile) AND (transmission OR brakes),” and “boat.” A search query comprises any combination of alphanumeric and/or nonalphanumeric characters. Referring to FIG. 2, a search query is the contents of prompt 202 at a given time point. In some embodiments, the search query is in the form of an http request.

In some embodiments, a user can, along with a search query, select an icon 510 for a vertical collection 144 by selecting any of the icons representing vertical collections 144 that are displayed. In typical embodiments, no icons for vertical collections 144 are displayed when prompt 202 is empty and, thus, at the stage when prompt 202 is empty, the user cannot select a vertical collection 144 in such embodiments. In some embodiments, icons for popular and/or sponsored vertical collections 144 are displayed when prompt 202 is empty.

In step 1404, a plurality of search results relevant to the submitted search query are obtained from search engine server 178. As illustrated in FIG. 1, from the perspective of computer 100, the search results are obtained from a remote computer (search engine server 178). A remote computer is any computer that is connected to a reference computer (e.g., device 100) via a wireless or wired connection. A remote computer can be in the same room as the reference computer, in a different room in the same building as the reference computer, in the same building as the reference computer, in a different building, in the same city, or a different city as the reference computer. In some embodiments, each respective search result in at least a portion of the plurality of search results obtained in step 1404 corresponds to a document in a plurality of documents. The plurality of documents are those documents referenced by a document index 150 (in the case where document index 150 was used to service the submitted search query) on one or more vertical collections 144 (in the case where one or more vertical collections 144 were used to service the submitted search query) that are deemed by search engine server 178 to be the most relevant to the search query. The plurality of documents may be any number of documents. In some embodiments, the plurality of documents is one thousand or fewer documents, one hundred or fewer documents, or fifty or fewer documents. In some embodiments, step 1404 comprises a determination as to whether a user has selected to make a search of a document index representative of the entire Internet (e.g., referring to FIG. 3, the user has pressed button 510). Referring to FIG. 3, a user can, for example, select button 510 when making a search query

If a user has elected to search a specific vertical collection 144, the search query is decomposed into atomic vertical search queries. An atomic search query consists of a single term or predicate condition. For example, the search query “(car OR automobile) AND (transmission OR brakes)” includes the single terms “car”, “automobile”, “transmission”, “brakes” and the predicate conditions of precedence “( )”, AND, as well as OR. In typical embodiments, only one of the atomic vertical search queries in a search query will be new or altered. Thus, the atomic vertical search query that is new or has been altered is first identified. To illustrate, consider the last search query received by search engine 178 from a given device 100 was “car OR auto” whereas in the current instance, the search is “car OR automobile”. The vertical search query “car OR automobile” is broken down to the atomic vertical search queries “car” and “automobile.” The atomic vertical search query “car” remains unchanged relative to the query and therefore is not hashed. The atomic vertical search query “automobile” on the other hand, previously had the form “auto” and is therefore is hashed. In some embodiments, rather than rehashing the full atomic vertical search “automobile” the hash of “auto” from the search request from the user is used and a cumulative hash is performed with the additional characters “mobile” in order to arrive at the full hash for “automobile” in the step. In some embodiments, such cumulative hashing is not performed. Cumulative hashing is preferable in some embodiments so that recommended verticals collections 144 can be returned to client computer 100 before the user has had a chance to enter many more keystrokes into prompt 202. Thus, any technique that will speed up the computation is desirable.

In some embodiments atomic vertical search queries are not hashed. In such embodiments, vertical index 138 is not ordered by the hash values of atomic vertical search queries. In some embodiments, more than one atomic vertical search query within the vertical search query is new or has been altered. In such embodiments, each new or altered atomic vertical search query is separately hashed when a search query is received. If a precursor expression is available for any of these altered atomic vertical search queries, the hash of such precursor expressions is used to speed up the hash of the corresponding altered atomic vertical search query.

In embodiments that make use of vertical collections 144 and in which the user elected to search a vertical collection, the vertical index list 140 for each new or altered atomic vertical search query in the vertical query is identified. In embodiments where vertical index 138 is a hash table, such as illustrated in FIG. 13, this operation is a simple hash lookup using the respective hash of each new or altered atomic vertical search query. In some embodiments, a hash is not used to accomplish this operation. For example, in some embodiments, vertical index 138 is some other form of data structure that contains vertical indices 138, such as an array, list, stack, queue, tree, or database. Such data structures are described in Brookshear, Computer Science, 2003, Addison-Wesley, New York, which is hereby incorporated by reference in its entirety. In some embodiments, the vertical index lists 140 that correspond to atomic vertical search queries that are not new in the search query are already known from previous computations and are therefore not obtained when the search results for a new search are requested. In some embodiments, the vertical index of each atomic vertical search query in the vertical search query is identified each time a search request is made. In embodiments where a user requested to search one or more verticals, the vertical index list 140 of each atomic vertical search query in the search query is identified.

In embodiments that make use of vertical collections, a list of recommended vertical collections 144 based upon a given search query from client computer 100 is composed and returned to the computer 100 that sent the search request. In the case where the search query includes only one atomic vertical search term, each of the names of the vertical collections 144 referenced in the vertical index 138 is extracted for the atomic vertical search term that was identified. In the case where the search query includes more than one atomic vertical search term, more work is required. Consider the case in which there are two atomic vertical search terms in a search query in which there is either no operator between the two search terms or the two search terms are joined by an “AND” operator. In this case, the names of the vertical collections 144 for each atomic vertical search term are first identified using the processes described above. So, if the atomic vertical search terms are term₁ and term₂, this operation results in the identification of the following:

| | |
|---|---|
| term₁ | VC₁₋₁, VC₁₋₂, . . . , VC_{1-N} |
| term₂ | VC₂₋₁, VC₂₋₂, . . . , VC_{2-M} |

Then, in order to identify a list of recommended vertical collections 144 in this instance, the intersection of each list of vertical collections 144 is taken in some embodiments of the present invention. This means that only those vertical collections 144 that are common to both vertical index lists 140 are included in the list of recommended vertical collections 144 in such embodiments. In some embodiments, in addition to the requirement that each recommended vertical collection be present in both index lists 140, each recommended vertical collection must have a minimum relevancy score(v, t).

Next consider the case in which two atomic vertical search terms are joined by an “OR” operator. Here, the union of the vertical collections 144 in the two vertical index lists 140 for the two search terms is taken. That is, vertical collections 144 that are in either vertical index list 140 are selected for inclusion in the list of names of candidate vertical collections that are sent back to client computer 100 in response to entry of the partial search query. As used herein, a partial search query is any query entered into prompt 202 before a vertical suggestion 144 or the “looksee” prompt 202 has been selected by a user. In some embodiments the relevancy score for each vertical collection 144 in each selected vertical index list 140 is also used to determine which vertical collections 144 are selected for the list of names of candidate vertical collections 144. For example, in some embodiments, those vertical collections 144 that are represented in the vertical index list 140 of both atomic vertical search terms are summed. Because of this summing operation, there is a tendency for those vertical collections 144 that are represented in the vertical index list 140 of both atomic vertical search terms to appear in the list or recommended vertical collections 144 in such embodiments. However, it is still quite possible in such embodiments for vertical collections 144 that appear in only one of the two vertical index lists 140 to be recommended if such vertical collections 144 have a high score. The following example illustrates the point. Consider the vertical indexes 140 for term₁ and term₂ in which the quality or relevancy score of each vertical collection 144 has been computed and in which term₁ and term₂ are related by an “OR” operator:

| | |
|---|---|
| term₁ | VC₁₅₀(score_{150, t1}), VC₁₇₀(score_{170, t1}), VC₁₇₅(score_{175, t1}) |
| term₂ | VC₁₅₁(score_{151, t2}), VC₁₇₀(score_{170, t2}), VC₁₇₅(score_{175, t2}) |

Thus, for purposes of determining which vertical collections 144 are to be incorporated into the list of recommended vertical collections responsive to a given search query, the following computations are made:

VC₁₅₀=score_{150,t1}

VC₁₇₀=score_{170,t1}+score_{170,t2}

VC₁₇₅=score_{175,t1}+score_{175,t2}

VC₁₅₁=score_{151,t2}

Here, VC₁₇₀ and VC₁₇₅ benefit from the summation of two scores whereas VC₁₅₀ and VC₁₅₁ each receive only one score. However, it is still quite possible that VC₁₅₀ or VC₁₅₁ may have a higher score than VC₁₅₀ and VC₁₅₁ and therefore be included in the list of recommended vertical collections.

For two atomic vertical search terms joined by a NOT operator, those vertical collections 144 in the vertical index list 140 of the negated search term are subtracted from the list of vertical collections 144 in the vertical index list 140 associated with the non-negated search term to arrive at a recommended list of vertical collections for a given partial search request. To illustrate, consider the vertical index lists 140 for term₁ and term₂ in which the quality or relevancy score of each vertical collection 144 has been computed and in which term₁ and term₂ are related by a “NOT” operator:

| | |
|---|---|
| Term₁ | VC₁₅₀(score_{150, t1}), VC₁₇₀(score_{170, t1}), VC₁₇₅(score_{175, t1}) |
| Term₂ | VC₁₅₁(score_{151, t2}), VC₁₇₀(score_{170, t2}), VC₁₇₅(score_{175, t2}) |

Thus, in this case, only the vertical collection VC₁₅₀ would be selected for inclusion in the list of recommended vertical collections 144.

More complex logical expressions can be built using combinations of atomic vertical search queries joined by Boolean expressions such as AND, OR as well as NOT. Moreover, precedence can be introduced using parentheses. Those of skill in the art will appreciate that other forms of logic can be used to merge or split lists of vertical collections 144 in vertical index lists 140 in order to arrive at a final set of list of recommended vertical collections 144 for a given partial search query and all such forms of logic are within the scope of the present invention.

In some embodiments, the list of recommended vertical collections 144 contains a maximum number of vertical collections 144. For some partial search expressions, the number of vertical collections 144 identified does not exceed this maximum. However, for some search expressions, the number of vertical collections 144 identified does exceed the maximum possible number of recommended vertical collections 144. In such embodiments, the term-based relevancy score associated with each vertical collection 144 is used to determine which vertical collections are included in the recommendation list of vertical collections for a given vertical search query. Only top scoring vertical collections 144 are selected for the list.

The above described process for identifying recommended vertical collections 144 based on a given search query lookup is designed to be fast. In some embodiments, a recommended list of vertical collections 144 is returned to client computer 100 between each character stroke entered by a user into prompt 202. Correspondingly, in some embodiments, client computer 100 sends a new search query each time the user enters a new character into prompt 202 of FIG. 3. In some embodiments, client computer 100 sends a new vertical search query each time an end of string signal is detected. Such an end of string signal is detected by client computer 100 in some embodiments when a pause in the typing of the user is detected. For example, referring to FIGS. 3 and 4, if there is a delay (e.g., a 1 second, a 2 second delay, a 3 second delay, etc.) between entering the “p” (FIG. 3) and the “e” (FIG. 4), then the end of string signal is detected by client computer 100 and the string “spe” is sent to the remote server (vertical engine server 178) as a partial search query. In some embodiments, an end of string signal is also detected when a space character or carriage return, or other designated character, is entered into prompt 202 by a user.

In some embodiments, a check is performed to determine whether an updated query has been received from client computer 100. For example, in some embodiments, a determination is made as to whether a new http request has arrived from the client computer 100 with an updated search query. If an updated search query has been received then recommended vertical collections are not reported. If a new or revised vertical search query has not arrived, then the recommended vertical collections 144 are reported to client computer 100 where they are displayed. In some embodiments, the recommended vertical collections are reported to client computer 100 even when a new search query has arrived from client computer 100.

In some embodiments, the list of recommended vertical collections that is returned to client computer 100 includes both the identity of the recommended vertical collections 144 (names) and a relevancy score for each vertical collection 144. Such relevancy scores are computed using any scoring function that assesses the relevance of a vertical collection 144 to given search query.

When a user selects a prompt for a vertical collection 144, the search query is made using the selected vertical collection 144. In such instances, step 1404 of FIG. 14 causes a search of the selected vertical collection 144 to be performed by search engine server 178 for those documents that are most relevant to the search query. In some embodiments, search engine 136 performs the search of the selected vertical collection 144. In some embodiments, a search engine that is specialized for only searching vertical collections 144 performs the search.

When a user elects to search a document index representative of the entire Internet (e.g., by selecting button 510 of FIG. 2), the search query is made using document index 150. In such instances, the document index 150 is searched by search engine 136 for those documents that are most relevant to the search query.

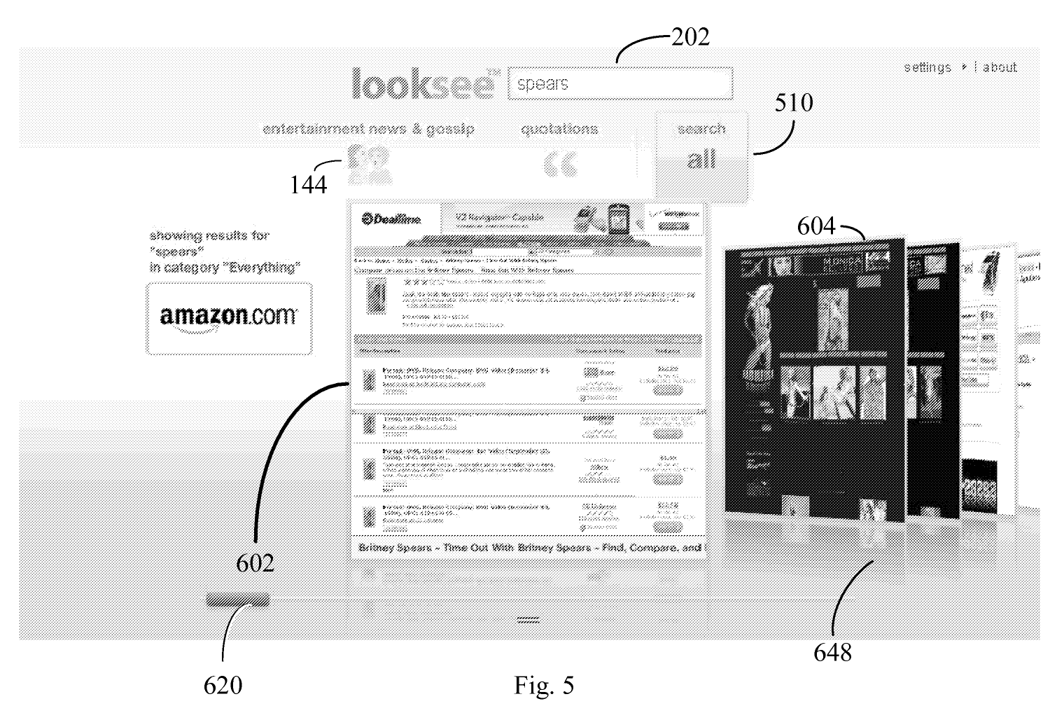

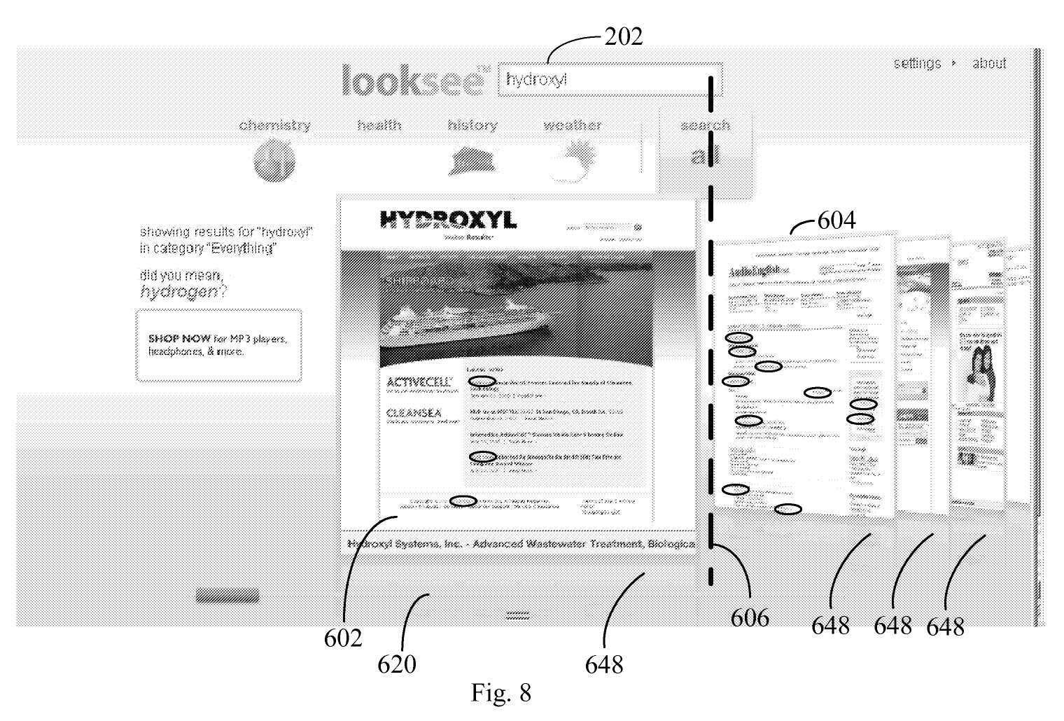

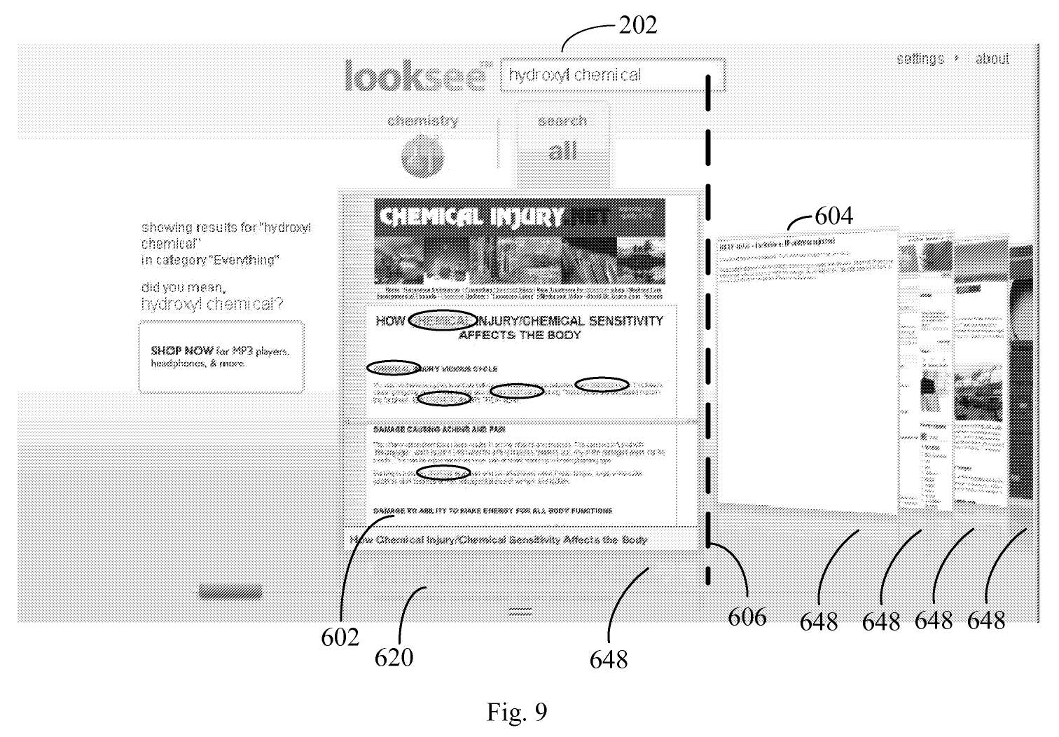

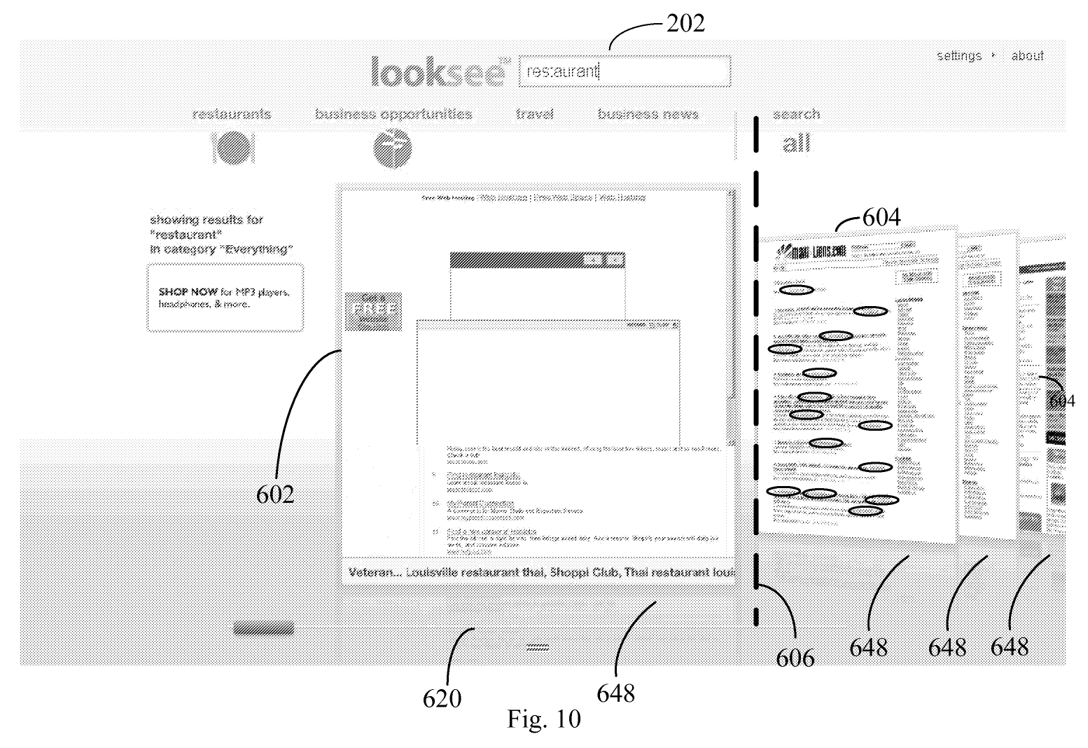

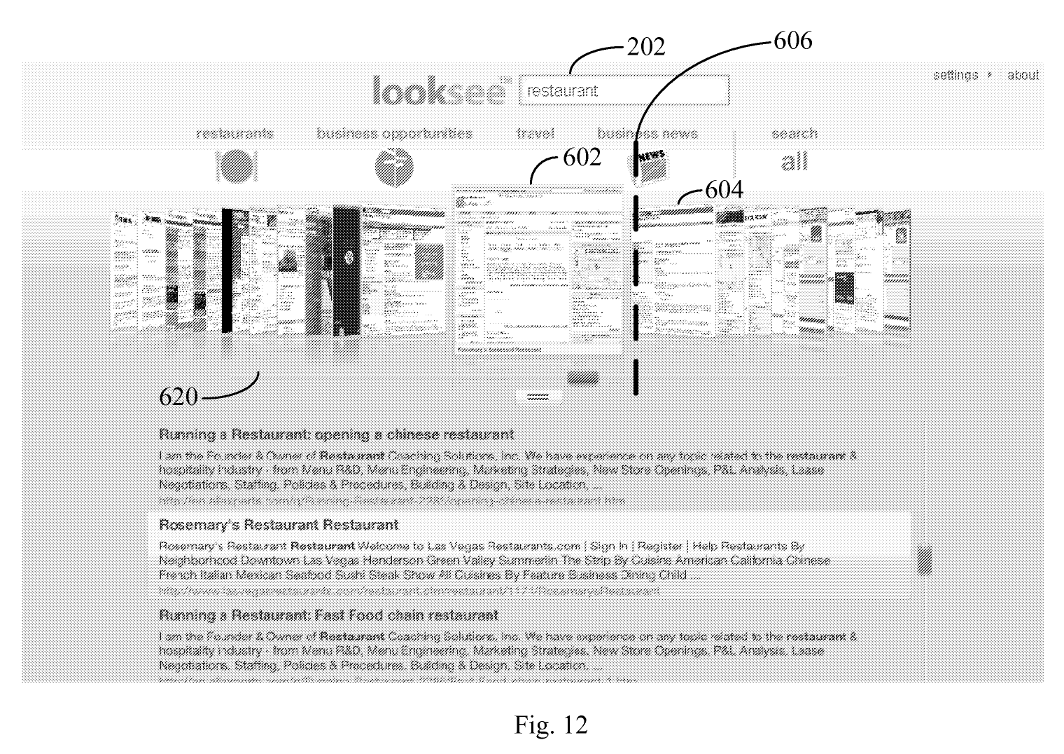

In step 1406, a first annotated static graphic representation of a first search result in the plurality of search results is displayed, for example, as shown in FIGS. 5-12, in accordance with instructions provided from display module 36 to web browser 34. In some embodiments, display module 36 and web browser 34 are, in fact, integrated into the same program. In some embodiments, display module 36 and web browser 34 are different programs. Thus, in summary, a submitted search query is received from a search requester on a client computer 100. Then, as described above, the search query is processed to obtain search results relevant to the submitted search query and these search results are submitted to the client device 100. In some embodiments, each search result in the plurality of search results comprises: (i) a source document or a reference to a source document 152, (ii) a static graphic representation 148 of the source document (where the static graphic representation 154 of the source document was obtained from the source document at a time before the submitted search query was received), and (iii) the location of where the words in the original search query appear in the static graphic representation 148. The location of where the words in the original search query appear in the static graphic representation of a given search result (document) are obtained from the word map 168 for the document.

In some embodiments, each search result in the plurality of search results comprises: (i) a source document or a reference to a source document 152, and (ii) an annotated static graphic representation of the source document in which words in the submitted search query are highlighted in the annotated static graphic representation. In some embodiments, an annotated static graphic representation is constructed by (i) using a stored word map 168 for a first static graphic representation 148 of a document in the plurality of documents in the search result to identify each area in the first static graphic representation that is occupied by a word in the submitted search query and (ii) highlighting each area in the first static graphic representation that is occupied by a word in the submitted search query thereby forming the first annotated static graphic representation. In some embodiments, for each annotated static graphic representation there is a corresponding static graphic representation, where a major if not only difference between the annotated static graphic representation and the corresponding static graphic representation is that words in the search request are annotated (e.g., highlighted) in the annotated static graphic representation but not in the static graphic representation. In some embodiments the above-described steps are performed on search engine server 178. In such embodiments it is not necessary to transmit the word map for a document in the plurality of documents that are hits to a search query to computer 100. For example, in such embodiments, if the search query is “spears” and the annotated static graphic representations are built on search engine server 178, then the static graphic representations 148 for the plurality of documents most relevant to “spears” are found using search engine server 178 and then the word maps 168 for these plurality of documents are used to highlight each instance of the word “spears” in these static graphic representations 148 thereby forming corresponding annotated static graphic representations 148. The annotated static graphic representations 148 are then sent from search engine server 178 to computer 100 where the annotated static graphic representations are displayed.

In some embodiments the steps of building annotated static graphic representations are performed on computer 100 rather than on search engine server 178. In such embodiments, the static graphic representation of each document in the plurality of documents in the search result together with at least those portions of the word maps 168 for the plurality of documents that pertain to the words in the search query are transmitted to the computer 100 from which the search query originated. For example, in such embodiments, if the search query is “spears” and the annotated static graphic representations are built on computer 100, then the static graphic representations for the plurality of documents most relevant to “spears” are found using search engine server 178 and then the portions of word maps 168 relating to the location of word “spears” in these static graphic representations 148 for the plurality of documents as well as the static graphic representations 148 for the plurality of documents themselves is sent from search engine server 178 to computer 100 where annotated static graphic representations are built and displayed.

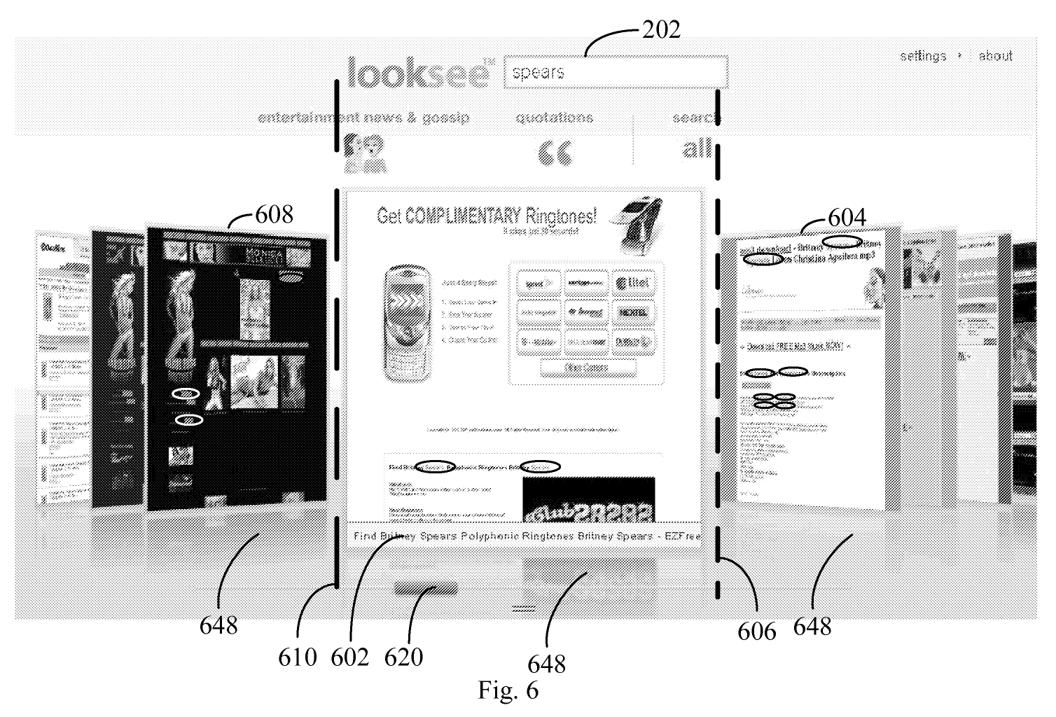

Referring to step 1406, and as illustrated in FIG. 6, an annotated static graphic representation of a search result in the plurality of search results is displayed. In FIG. 6, each area in the annotated static graphic representation that is occupied by the search query “spears” in the submitted search query is highlighted in yellow. The yellowed areas in the static graphic representation are illustrated by black or white ovals. The annotations in the annotated static graphic representations can be the highlighting of search terms in the static graphic representations using any color (e.g., red, orange, yellow, green, blue, indigo, violet, or any combination thereof), underlining the search terms, bold facing the search terms, and/or circling or otherwise marking the search terms that appear in the static graphic representations thereby forming the corresponding annotated static graphic representations.

Referring to optional step 1408 of FIG. 14 and as illustrated for example in FIG. 6, in some embodiments, the first annotated static graphic representation is displayed in a center position 602 of a graphic output device 6. Moreover, a second annotated static graphic representation of a second search result in the plurality of search results is displayed in a first off-center position 604 of the graphic output device, where the second annotated static graphic representation is displayed rotated (e.g., at least one degree out of the plane of the graphic output device 6, at least two degrees out of the plane of the graphic output device 6, at least three degrees out of plane of the graphic output device 6, at least five degrees out of plane of the graphic output device 6) about a first axis of rotation 606 that lies between the center position and the first off-center position 604 of the graphic output device. Note that the placement of position 604 to the right of position 602 is merely exemplary and that position 604 can in fact be at any position relative to position 602. Therefore, the position of the first axis of rotation 606 in FIG. 6 is merely exemplary. The second annotated static graphic representation is constructed by the method comprising (i) using a stored word map for a second static graphic representation of a document in the plurality of documents related to the submitted search query to identify each area in the second static graphic representation 148 that is occupied by a word in the submitted search query and (ii) highlighting or otherwise marking each area in the second static graphic representation that is occupied by a word in the submitted search query thereby forming the second annotated graphic representation.

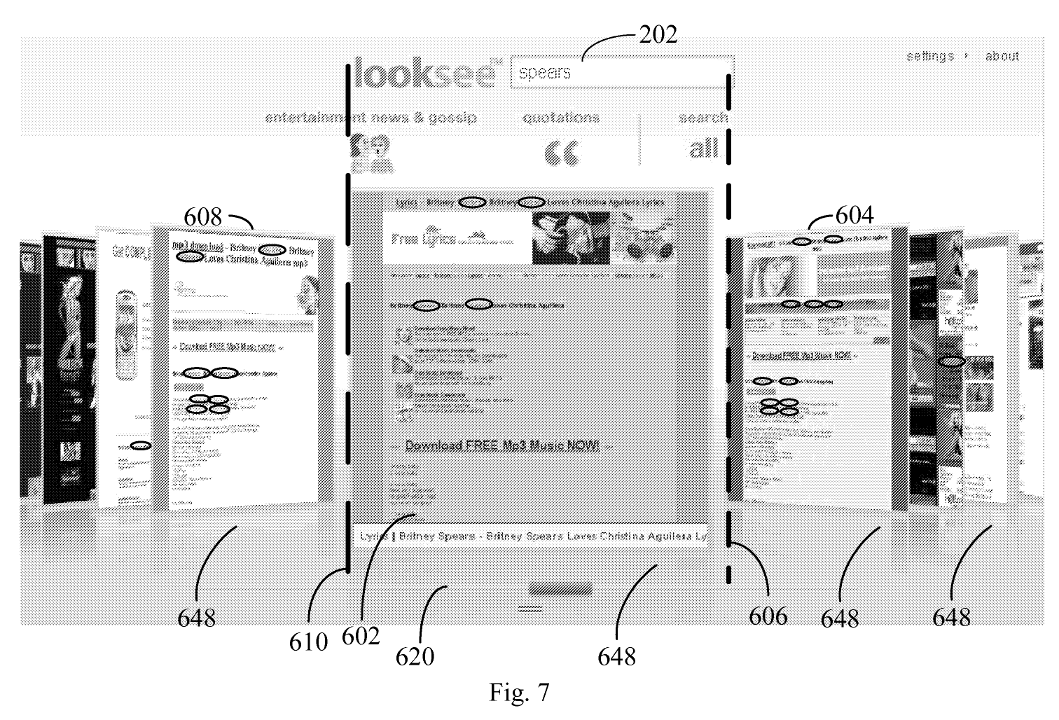

Referring to FIG. 6, in some embodiments, responsive to a selection of the annotated static graphic representation of the source document in the first off-center position 604, the annotated search result at position 604 is shifted from the first off-center position 604 to the center position 602. This transition from the first off-center position 604 to the center position 602 is illustrated by FIGS. 6 and 7 where a user has clicked on the annotated static graphic representation in position 604 twice so that annotated static graphic representations have shifted to the left twice in the transition from FIG. 6 to FIG. 7.

Referring to FIG. 5, in some embodiments, in the initial display of search results, one annotated static graphic representation is displayed in the center position 602 and all the remaining search results are cascaded to the right of the center position 602 (or some other direction such as to the left of the center position 602) on the display. The set of annotated static graphic representation cascaded to the right of the center position 602 of the display includes an annotated static graphic representation of a first off-center position 604. Responsive to a selection of the annotated static graphic representation in the first off-center position 604 (or any of the annotated static graphic representations cascaded to the right of the first off-center position 604), the annotated static graphic representation in the center position 602 in FIG. 5 is shifted to a second off-center position 608 of the graphic output device (as seen in FIG. 6), thereby causing the annotated static graphic representation that was in center position 602 to now be displayed at the second off-center position 608 rotated (e.g., at least one degree out of the plane of the graphic output device 6, at least two degrees out of the plane of the graphic output device 6, at least three degrees out of plane of the graphic output device 6, at least five degrees out of plane of the graphic output device 6) about a second axis of rotation 610 that lies between the center position 602 and the second off-center position 608 of the graphic output device. As part of this action, the annotated static graphic representation occupying first off-center position 604 in FIG. 5 is shifted to the center position (at position 602) of the graphic output device where it is now displayed in a manner that is no longer rotated about the first axis of rotation 606. As further part of this action, an annotated static graphic representation of a third search result in the plurality of search results is now displayed in the first off-center position 604 of the graphic output device rotated about the first axis of rotation 606. The movements described here are illustrated in the transition from FIG. 5 to FIG. 6, where the annotated static graphic position in position 604 has been selected twice, so that each annotated static graphic representation has shifted two positions to the left. In other words, the steps outlined above in this paragraph each occur twice.

Just as annotated static graphic representations can be shifted from the first off-center position 604, to the center position 602, and then to the second off-center position 608, the reverse is also true. When a user clicks on an annotated static graphic representation occupying the second off-center position 608, the annotated static graphic representation occupying the second off-center position 608 is shifted to the center position 602 and the graphic representation formally occupying the center position 602 is shifted to the first off-center position 604. Thus, in the above-identified manner, a user can easily view the annotated static graphic representation of search result hits in a seamless and efficient manner.

In some embodiments, responsive to a selection of the annotated static representation of the source document of the search result occupying the center position 602 of the graphic output device 6, the size of the annotated static graphic representation is enlarged. For instance, in some embodiments, the annotated static representation of the source document is enlarged by at least 10 percent, at least 20 percent, at least 30 percent, or at least 100 percent. Furthermore, responsive to a selection of a portion of the graphic output device 6 outside of the annotated static graphic representation of the source document occupying the center position 602 while it is in its enlarged state, the size of the annotated static graphic representation of the source document is reduced back to the original size that it was before it was enlarged.

In some embodiments, responsive to a selection of the annotated static representation occupying the center position 602, a web page impression from the source document of the first search result is retrieved. In other words, a “live” version of the document obtained from the URL or other address where the document corresponding to the annotated static graphic representation was found while building the document index 150 is obtained and used to replace the static graphic representation of the source document.

In some embodiments, responsive to a selection of the annotated static representation of the source document of the search result occupying the center position 602 of the graphic output device, the annotated static graphic representation of the source document is flipped from a first side to a reverse side so that the reverse side of the annotated static graphic representation is shown. In some embodiments, the reverse side of the annotated static graphic representation contains information associated with the annotated static graphic representation (e.g., source of document, size of document, file type of document, a date and/or time when the annotated static graphic representation of the document was created, a date and/or time when the document was accessed during a web crawl, etc.). In some embodiments, the annotated static graphic representation is flipped to the opposite side each time a first designated portion of the annotated static graphic representation is selected (e.g., the top portion) and is enlarged when a second designated portion of the annotated static graphic representation is selected (e.g., anything outside of the top portion).

In some instances, a toggle bar 620 is provided. See, for example, FIG. 6. When the search requester pulls the toggle bar 620 in a first direction (e.g., to the left), the displayed annotated static graphic representations of the search results shift from the first off-center position 604 to the center position 602, and from the center position 602 to the second off-center position 608 responsive to the pull in the first direction. When the search requester pulls the toggle bar in a second direction (e.g., to the right), the annotated static graphic representations of search results shift from the second off-center position 608 to the center position 602, and from the center position 602 to the first off-center position 604 responsive to the pull in the second direction.

In some embodiment, one of the annotated static graphic representations displayed in the first off-center position 604, the center position 602, or the second off-center position 608 is an advertisement. In other words, rather than being a “hit” to a search query that was obtained from a vertical collection 144 or a document index 150, the annotated static graphic representation is an advertisement for services or products that may or may not be related to the search query. In some embodiments, the use of advertisements in this manner is accomplished by embedding the advertisement into the plurality of search results as a static graphic representation so that, when the search requester pulls the toggle bar 620 in the first direction or the second direction, an advertisement is displayed in the center position 602.

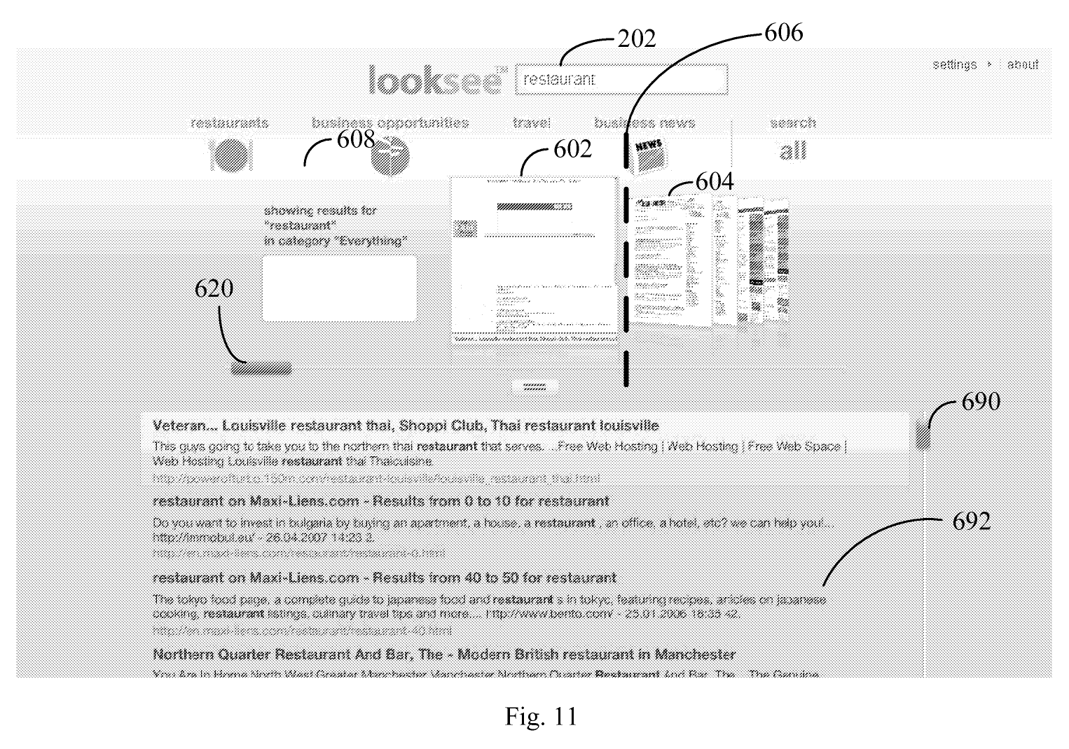

Referring to FIG. 11, in some embodiments a first toggle bar 620 is provided on the graphic output device. Moreover, a second toggle bar 690 is provided on the graphic output device. Further still, a list 692 comprising a text representation of one or more search results in the plurality of search results is provided. In such embodiments, when the search requester pulls the first toggle bar 620 or the second toggle bar 690 in a first direction, annotated static graphic representations of search results in the plurality of search results shift from the first off-center 604 position to the center position 602, and from the center position to a second off-center position (e.g., position 608), and the list 692 scrolls in a first direction, responsive to the pull in the first direction. Furthermore, when the search requester pulls the first toggle bar 620 or the second toggle bar 690 in a second direction, annotated static graphic representations of search results in the plurality of search results shift from the second off-center position 608 to the center position 602, and from the center position to the first off-center position 604, and the list 692 scrolls in a second direction, responsive to the pull in the second direction. In some embodiments, there is a one-to-one correspondence between the text representation of one or more search results in the plurality of search results appearing in list 692 such that the top text representation in the list 692 references that same document in the plurality of documents that are hits to the received search request that is represented by the annotated static graphic representation occupying center position 602 at any given time. Thus, as the user pulls the first toggle 620 or the second toggle 690, the text representation appearing at the top of the list 692 and the annotated static graphic representation occupying center position 602 move in a coordinated fashion so that when the annotated static graphic representation moves from center position 602 the text representation appearing at the top of the list 692 moves to a position other than at the top of the list.

In some embodiments, responsive to a selection and drag of the static graphic representation of the source document occupying the first off-center position 604, the center position 602, or the second off-center position 608, a copy of the annotated static graphic representation of the source document of the first search result (or the static graphic representation of the source document of the first search result) is stored in a predetermined or user specified location on the client device (e.g., a location in memory 20 and/or memory 114 of client device 100). This is advantageous for storing the annotated static graphic representation and/or static graphic representation of hits to search queries.

In some embodiments, when the annotated static graphic representation occupying the center position 602 is displayed for a predetermined amount of time without user input (e.g., for two seconds or more, for three seconds or more, for five seconds or more) the annotated static graphic representation is automatically transformed, without user input, to a live impression from the source document, in the plurality of documents, corresponding to the annotated static graphic representation.

In some embodiments, one or more advertisements are embedded into the plurality of search results returned to a device 100 by search engine server 178. In some embodiments, a static graphic representation of a source document is a graphic representation of an entire web page at a time before the submitted search query was received. In some embodiments, the displaying step 1416 further comprises displaying a reflection 648 of annotated the static graphic representation below the static graphic representation. A reflection 648 is illustrated in FIG. 5-13.

Referring to FIGS. 5 and 14, in some embodiments a submitted search query is received from a search requester and, responsive to the search query, a plurality of search results relevant to the submitted search query are obtained from a document index or one or more vertical collections, where each respective search result in at least a portion of the plurality of search results comprises the annotated static graphic representation of a document corresponding to the respective search result in the plurality of search results. Furthermore, an interactive widget is embedded as a search result in the plurality of search results. A first annotated static graphic representation of a search result in the plurality of search results is displayed in a center position 602 of a graphic output device Furthermore, an annotated static graphic representation of each of one or more search results in the plurality of search results, other than the annotated static graphic representation displayed in the center position 602, are displayed in a plurality of off-center positions 604 of the graphic output device, where a search result in the one or more search results is the interactive widget, and where the annotated static graphic representations of the one or more search results in the plurality of search results in the plurality of off-center positions of the graphic output device are rotated (e.g., at least one degree out of the plane of the graphic output device 6, at least two degrees out of the plane of the graphic output device 6, at least three degrees out of plane of the graphic output device 6, at least five degrees out of plane of the graphic output device 6) about a first axis of rotation 606 that lies between the center position 602 and the plurality of off-center positions 604 of the graphic output device. When a user uses the selection interactions described above to cause the widget to occupy the center position 602 on the display 7, the widget become activated. When activated, information entered into the widget is transmitted to a predetermined address of a remote computer where the information is process and information is returned to the interactive widget. In this manner, the interactive widget can be used to order products, rentals, answer surveys, join network social clubs, play interactive computer assisted games, or to perform any other activity that is facilitated by a graphical user interface.

In some embodiments, each of the documents in document index 150 and/or a vertical collection 144 that have been used by search engine 136 to perform a search based upon the search query provided by the user, are independently classified into one or more categories. For example the first document in the search results may be deemed to in categories one, three, five, and seven (e.g., sports, major league baseball, blogs, and news) and the second document in the search results may be deemed to be in categories five and seven (blogs and news). Such categorization provides advantages. For example, the search requester can request to remove a particular search result from the plurality of search results that were obtained in response to the user's original search query. For example, consider the above case in which the categories of the first document and the second document are described. Suppose that the search request removes the second document. In response to this request, the original search query is resubmitted with the specific request to not retrieve documents that are only in the blogs category or are only in the news category (or are only in both the blogs category and the news category). As a result, new search results relevant to the modified search query are obtained. Advantageously, the new search results are focused on the categories of documents in document index 150 or vertical collection 144 that the user did not exclude from the search.

In typical embodiments, the static graphic representation of the source document of each of the hits in the search results is a graphic representation of an entire web page taken from the location where the source document resides at a time before the submitted search query was received. For instance, the graphic representation of the entire web page may be taken when the source document is crawled during construction of the vertical collection.

In some embodiments, the method further comprises receiving, prior to obtaining the search results, a designation of a vertical collection in a plurality of vertical collections from the search requester. For instance, the user can select any of the icons for vertical collections 144 that are illustrated in FIGS. 3 through 12. In such embodiments, the search query and the designation of the vertical collection is submitted to search engine server 178. Responsive to this request from the user, search engine 136 (or a specialized search engine used to search the designated vertical collection 144) searches the designated vertical collection 144 with the search query and returns a plurality of search results to the client 100.

In some embodiments, responsive to a search query from a search requester, client 100 submits the search query to search engine server 178 without a designation of a vertical collection 144. In such instances, search engine 136 of search engine server 178 searches document index 150 using the search query and provides the search results back to client 100. Client 100 then displays the plurality of search results from the search engine server 178, for example, in the form of annotated static graphic annotations. In such embodiments, the document index that is searched, document index 150, is representative of the entire Internet (e.g., document index 150 is a random sampling of all the documents addressable by the Internet). This means that, typically, the documents in document index 150 are not restricted to a particular category of documents, such as sports, but rather can be of any category found in the Internet. In some embodiments, offensive documents are excluded from document index 150.

### Computer Program Products and Computer Implementations

Still another aspect of the present application provides a computer program product for use in conjunction with a computer system, the computer program product comprising a computer readable storage medium and a computer program mechanism embedded therein, the computer program mechanism comprising instructions for performing any of the methods disclosed herein. For instance, in one embodiment, the computer program mechanism comprises instructions for receiving a submitted search query from a search requester as well as instructions for obtaining a plurality of search results relevant to the submitted search query from a document index or one or more vertical collection, where each respective search result in at least a portion of the plurality of search results corresponds to a document in a plurality of documents. The computer program mechanism further comprises instructions for displaying a first annotated static graphic representation of a first search result in the plurality of search results, where the first annotated static graphic representation is constructed by (i) using a stored word map for a first static graphic representation of a document in the plurality of documents to identify each area in the first static graphic representation that is occupied by a word in the submitted search query and (ii) highlighting each area in the first static graphic representation that is occupied by a word in the submitted search query thereby forming the first annotated static graphic representation. In some embodiments, the first annotated static graphic representation is optionally displayed in a center position of a graphic output device and the computer program mechanism optionally further comprises instructions for displaying a second annotated static graphic representation of a second search result in the plurality of search results in a first off-center position of the graphic output device, where the second static graphic representation is displayed rotated about a first axis of rotation that lies between the center position and the first off-center position of the graphic output device, where the second annotated static graphic representation is constructed by the method comprising (i) using a stored word map for a second static graphic representation of a document in the plurality of documents to identify each area in the second static graphic representation that is occupied by a word in the submitted search query and highlighting each area in the second static graphic representation that is occupied by a word in the submitted search query thereby forming the second annotated static graphic representation.

Another aspect of the present invention comprises a computer comprising a main memory, a processor and one or more programs (e.g. display module 36) stored in the main memory and executed by the processor that includes instructions for performing any of the methods disclosed herein. For example, in one embodiment, the one or more programs collectively include instructions for receiving a submitted search query from a search requester as well as instructions for obtaining a plurality of search results relevant to the submitted search query from a document index or one or more vertical collection, where each respective search result in at least a portion of the plurality of search results corresponds to a document in a plurality of documents. The one or more programs also collectively include instructions for displaying a first annotated static graphic representation of a first search result in the plurality of search results, where the first annotated static graphic representation is constructed by (i) using a stored word map for a first static graphic representation of a document in the plurality of documents to identify each area in the first static graphic representation that is occupied by a word in the submitted search query and (ii) highlighting each area in the first static graphic representation that is occupied by a word in the submitted search query thereby forming the first annotated static graphic representation. In some embodiments, the first annotated static graphic representation is optionally displayed in a center position of a graphic output device and the one or more programs optionally collectively further include instructions for displaying a second annotated static graphic representation of a second search result in the plurality of search results in a first off-center position of the graphic output device, where the second static graphic representation is displayed rotated about a first axis of rotation that lies between the center position and the first off-center position of the graphic output device, where the second annotated static graphic representation is constructed by the method comprising (i) using a stored word map for a second static graphic representation of a document in the plurality of documents to identify each area in the second static graphic representation that is occupied by a word in the submitted search query and highlighting each area in the second static graphic representation that is occupied by a word in the submitted search query thereby forming the second annotated static graphic representation.

Still another aspect of the present application provides a system for providing search results responsive to a search query that comprises means for carrying out any of the methods disclosed in the instant application. One embodiment of such a system is illustrated in FIG. 1 and describe above. In one embodiment, such a system comprises means for receiving a submitted search query from a search requester as well as means for obtaining a plurality of search results relevant to the submitted search query from a document index or one or more vertical collection, where each respective search result in at least a portion of the plurality of search results corresponds to a document in a plurality of documents. The system further includes means for displaying a first annotated static graphic representation of a first search result in the plurality of search results, where the first annotated static graphic representation is constructed by (i) using a stored word map for a first static graphic representation of a document in the plurality of documents to identify each area in the first static graphic representation that is occupied by a word in the submitted search query and (ii) highlighting each area in the first static graphic representation that is occupied by a word in the submitted search query thereby forming the first annotated static graphic representation. In some embodiments, the first annotated static graphic representation is optionally displayed in a center position of a graphic output device and the system further includes means for displaying a second annotated static graphic representation of a second search result in the plurality of search results in a first off-center position of the graphic output device, where the second static graphic representation is displayed rotated about a first axis of rotation that lies between the center position and the first off-center position of the graphic output device, where the second annotated static graphic representation is constructed by the method comprising (i) using a stored word map for a second static graphic representation of a document in the plurality of documents to identify each area in the second static graphic representation that is occupied by a word in the submitted search query and highlighting each area in the second static graphic representation that is occupied by a word in the submitted search query thereby forming the second annotated static graphic representation.

### Vertical Collections are Optional

The use of vertical collections 144 is entirely optional in the present disclosure. Thus, the present disclosure specifically encompasses embodiments that do not make use over vertical collections. In such embodiments, icons for vertical collections 144 are not displayed on client device 100.

### REFERENCES CITED AND ALTERNATIVE EMBODIMENTS

All references cited herein are incorporated herein by reference in their entirety and for all purposes to the same extent as if each individual publication or patent or patent application was specifically and individually indicated to be incorporated by reference in its entirety for all purposes.

The present invention can be implemented as a computer program product that comprises a computer program mechanism embedded in a computer readable storage medium. For instance, the computer program product could contain the program modules shown in FIG. 1. These program modules can be stored on a CD-ROM, DVD, magnetic disk storage product, or any other computer readable data or program storage product. The software modules in the computer program product may also be distributed electronically, via the Internet or otherwise, by transmission of a computer data signal (in which the software modules are embedded).

Many modifications and variations of this invention can be made without departing from its spirit and scope, as will be apparent to those skilled in the art. The specific embodiments described herein are offered by way of example only. The embodiments were chosen and described in order to best explain the principles of the invention and its practical applications, to thereby enable others skilled in the art to best utilize the invention and various embodiments with various modifications as are suited to the particular use contemplated. The invention is to be limited only by the terms of the appended claims, along with the full scope of equivalents to which such claims are entitled.

What is claimed:

1. A method for displaying a search result, the method comprising:
(A) receiving a submitted search query from a search requester;
(B) obtaining a plurality of search results relevant to the submitted search query from a document index or one or more vertical collections, wherein each respective search result in at least a portion of the plurality of search results corresponds to a document in a plurality of documents; and
(C) displaying a first annotated static graphic representation of a first search result in said plurality of search results, wherein the first annotated static graphic representation is constructed by the method comprising:
(i) using a stored word map for a first static graphic representation of a document in the plurality of documents to identify each area in the first static graphic representation that is occupied by a word in the submitted search query; and
(ii) highlighting each area in the first static graphic representation that is occupied by a word in the submitted search query thereby forming the first annotated static graphic representation.

2. The method of claim 1, wherein the displaying step (C) displays the first annotated static graphic representation in a center position of a graphic output device, the method further comprising:
(D) displaying a second annotated static graphic representation of a second search result in said plurality of search results in a first off-center position of the graphic output device, wherein the second annotated static graphic representation is displayed rotated about a first axis of rotation that lies between the center position and the first off-center position of the graphic output device, and wherein the second annotated static graphic representation is constructed by the method comprising:
(i) using a stored word map for a second static graphic representation of a document in the plurality of documents to identify each area in the second static graphic representation that is occupied by a word in the submitted search query; and
(ii) highlighting each area in the second static graphic representation that is occupied by a word in the submitted search query thereby forming the second annotated graphic representation.

3. The method of claim 3, the method further comprising, responsive to a selection of the second annotated static graphic representation in the first off-center position, the steps of:
shifting the first annotated static graphic representation to a second off-center position of the graphic output device; thereby causing the first annotated static graphic representation to be displayed at the second off-center position rotated about a second axis of rotation that lies between the center position and the second off-center position of the graphic output device;
shifting the second annotated static graphic representation to the center position of the graphic output device; thereby causing the second annotated static graphic representation to be displayed at the center position in a manner that is no longer rotated about the first axis of rotation; and
displaying a third annotated static graphic representation of a third search result in said plurality of search results in the first off-center position of the graphic output device; wherein the third annotated static graphic representation is displayed rotated about the first axis of rotation.

4. The method of claim 3, the method further comprising, responsive to a selection of the first annotated static graphic representation in the second off-center position, the steps of:
shifting the first annotated static graphic representation to the center position of the graphic output device; thereby causing the first annotated static graphic representation to be displayed at the center position in a manner that is no longer rotated about the second axis of rotation; and
shifting the second annotated static graphic representation to the first off-center position; thereby causing the second annotated static graphic representation to be displayed at the first off-center position in a manner that is rotated about the first axis of rotation.

5. The method of claim 4, the method further comprising removing the third annotated static graphic representation from the first off-center position.

6. The method of claim 1, the method further comprising, responsive to a selection of the first annotated static graphic representation in said center position of the graphic output device, the step of enlarging a size of the first annotated static graphic representation.

7. The method of claim 6, the method further comprising, responsive to a selection of a portion of the graphic output device outside of the first annotated static graphic representation when the first annotated static graphic representation is in an enlarged state, the step of reducing the size of the first annotated static graphic representation to an original size.

8. The method of claim 1, the method further comprising, responsive to a selection of the first annotated static graphic representation, the steps of:
retrieving a web page impression from the source document corresponding to the first annotated static graphic representation; and
replacing the first annotated static graphic representation with the web page impression.

9. The method of claim 1, the method further comprising, responsive to a selection of the first annotated static graphic representation, the step of flipping the first annotated static graphic representation from a first side to a reverse side so that the reverse side of the first annotated static graphic representation is shown.

10. The method of claim 9, wherein the reverse side of the first annotated static graphic representation contains information about the first annotated static graphic representation.

11. The method of claim 2, the method further comprising:
providing a first toggle bar on the graphic output device, wherein,
when the search requester pulls the first toggle bar in a first direction, annotated static graphic representations of search results in the plurality of search results shift from the first off-center position to the center position, and from the center position to a second off-center position responsive to the pull in the first direction; and
when the search requester pulls the first toggle bar in a second direction, annotated static graphic representations of search results in the plurality of search results shift from the second off-center position to the center position, and from the center position to the first off-center position responsive to the pull in the second direction.

12. The method of claim 11, the method further comprising embedding an advertisement into the plurality of search results as a static graphic representation, wherein, when the search requester pulls the first toggle bar in the first direction or the second direction, an advertisement is displayed in the center position.

13. The method of claim 2, the method further comprising:
providing a first toggle bar on the graphic output device;
providing a second toggle bar on the graphic output device;
displaying a list comprising a text representation of one or more search results in the plurality of search results;
wherein,
when the search requester pulls the first toggle bar or the second toggle bar in a first direction, annotated static graphic representations of search results in the plurality of search results shift from the first off-center position to the center position, and from the center position to a second off-center position, and the list scrolls in a first direction, responsive to the pull in the first direction; and
when the search requester pulls the first toggle bar or the second toggle bar in a second direction, annotated static graphic representations of search results in the plurality of search results shift from the second off-center position to the center position, and from the center position to the first off-center position, and the list scrolls in a second direction, responsive to the pull in the second direction.

14. The method of claim 1, the method further comprising, responsive to a selection and drag on the first annotated static graphic representation in the direction of a predetermined position on the graphic output device, storing a copy of the first annotated static graphic representation on a client device.

15. The method of claim 1, the method further comprising embedding an advertisement into the plurality of search results as a static graphic representation.

16. The method of claim 1, wherein the static graphic representation of a document corresponding to the respective search result is a graphic representation of an entire web page at a time before the submitted search query was received.

17. The method of claim 1, wherein the displaying step (C) further comprises:
(iii) displaying a reflection of the first annotated static graphic representation below the first annotated static graphic representation.

18. The method of claim 2, wherein
the displaying step (C) further comprises:
(iii) displaying a reflection of the first annotated static graphic representation below the static graphic representation; and
the displaying step (D) further comprises:
(iii) displaying a reflection of the second annotated static graphic representation below the second annotated static graphic representation.

19. The method of claim 1, the method further comprising:
(D) embedding an interactive widget as a search result in the plurality of search results; and
(E) displaying an annotated static graphic representation of one or more search results in said plurality of search results, other than the first annotated static representation, in a plurality of off-center positions of the graphic output device, wherein a search result in said one or more search results is said interactive widget, and wherein each annotated static graphic representation of one or more search results in said plurality of search results in the plurality of off-center positions of the graphic output device are rotated about a first axis of rotation that lies between the center position and the plurality of off-center positions of the graphic output device.

20. A computer program product for use in conjunction with a computer system, the computer program product comprising a computer readable storage medium and a computer program mechanism embedded therein, the computer program mechanism comprising:
(A) instructions for receiving a submitted search query from a search requester;
(B) instructions for obtaining a plurality of search results relevant to the submitted search query from a document index or one or more vertical collection, wherein each respective search result in at least a portion of the plurality of search results corresponds to a document in a plurality of documents;
(C) instructions for displaying a first annotated static graphic representation of a first search result in said plurality of search results, wherein the first annotated static graphic representation is constructed by the method comprising:
(i) using a stored word map for a first static graphic representation of a document in the plurality of documents to identify each area in the first static graphic representation that is occupied by a word in the submitted search query; and
(ii) highlighting each area in the first static graphic representation that is occupied by a word in the submitted search query thereby forming the first annotated static graphic representation.

21. The computer program product of claim 20, wherein the instructions for displaying (C) display the first annotated static graphic representation in a center position of a graphic output device, the computer program mechanism further comprising:
(D) instructions for displaying a second annotated static graphic representation of a second search result in said plurality of search results in a first off-center position of the graphic output device, wherein the second static graphic representation is displayed rotated about a first axis of rotation that lies between the center position and the first off-center position of the graphic output device, wherein the second annotated static graphic representation is constructed by the method comprising:
(i) using a stored word map for a second static graphic representation of a document in the plurality of documents to identify each area in the second static graphic representation that is occupied by a word in the submitted search query; and
(ii) highlighting each area in the second static graphic representation that is occupied by a word in the submitted search query thereby forming the second annotated static graphic representation.

22. A computer, comprising:
a main memory;
a processor; and
one or more programs, stored in the main memory and executed by the processor, the one or more programs collectively including instructions for:
(A) receiving a submitted search query from a search requester;
(B) obtaining a plurality of search results relevant to the submitted search query from a document index or one or more vertical collection, wherein each respective search result in at least a portion of the plurality of search results corresponds to a document in a plurality of documents; and
(C) displaying a first annotated static graphic representation of a first search result in said plurality of search results, wherein the first annotated static graphic representation is constructed by the method comprising:
(i) using a stored word map for a first static graphic representation of a document in the plurality of documents to identify each area in the first static graphic representation that is occupied by a word in the submitted search query; and
(ii) highlighting each area in the first static graphic representation that is occupied by a word in the submitted search query thereby forming the first annotated static graphic representation.

23. The computer program product of claim 22, wherein the instructions for displaying (C) display the first annotated static graphic representation in a center position of a graphic output device, the one or more programs collectively further including instructions for:
(D) displaying a second annotated static graphic representation of a second search result in said plurality of search results in a first off-center position of the graphic output device, wherein the second static graphic representation is displayed rotated about a first axis of rotation that lies between the center position and the first off-center position of the graphic output device, wherein the second annotated static graphic representation is constructed by the method comprising:
(i) using a stored word map for a second static graphic representation of a document in the plurality of documents to identify each area in the second static graphic representation that is occupied by a word in the submitted search query; and
(ii) highlighting each area in the second static graphic representation that is occupied by a word in the submitted search query thereby forming the second annotated static graphic representation.

24. The method of claim 1, wherein the plurality of search results are obtained from a remote computer.

25. The computer program product of claim 20, wherein the instructions for obtaining a plurality of search results obtain the search results from a remote computer.

26. The computer of claim 22, wherein the instructions for obtaining a plurality of search results obtain the search results from a remote computer.

27. The method of claim 1, wherein the plurality of search results relevant to the submitted search query are obtained from one or more vertical collections stored on a remote computer.

28. The computer program product of claim 20, wherein the instructions for obtaining a plurality of search results obtain the search results from one or more vertical collections stored on a remote computer.

29. The computer of claim 22, wherein the instructions for obtaining a plurality of search results obtain the search results from one or more vertical collections stored on a remote computer.

30. The method of claim 1, wherein the plurality of search results relevant to the submitted search query are obtained from a document index stored on a remote computer.

31. The computer program product of claim 20, wherein the instructions for obtaining a plurality of search results obtain the search results from a document index stored on a remote computer.

32. The computer of claim 22, wherein the instructions for obtaining a plurality of search results obtain the search results from a document index stored on a remote computer.

33. The computer of claim 1, wherein the plurality of search results comprises the first annotated static graphic representation and the using step (i) and the highlighting step (ii) are performed on a computer other than a computer that performs the receiving step (A).

34. The computer program product of claim 20, wherein the plurality of search results comprises the first annotated static graphic representation and the using step (i) and the highlighting step (ii) are performed on a computer other than a computer that performs the instructions for receiving (A).

35. The computer of claim 22, wherein the plurality of search results comprises the first annotated static graphic representation and the using step (i) and the highlighting step (ii) are performed on a computer other than a computer that performs the instructions for receiving (A).

36. The computer of claim 1, wherein the plurality of search results comprises the first static graphic representation and the using step (i) and the highlighting step (ii) are performed on the same computer that performs the receiving step (A).

37. The computer program product of claim 20, wherein the plurality of search results comprises the first static graphic representation and the using step (i) and the highlighting step (ii) are performed on the same computer that performs the instructions for receiving (A).

38. The computer of claim 22, wherein the plurality of search results comprises the first static graphic representation and the using step (i) and the highlighting step (ii) are performed on the same computer that performs the instructions for receiving (A).

39. The computer of claim 1, wherein the plurality of search results comprises a name of each of one or more suggested vertical collections, wherein the one or more suggested vertical suggestions are determined based upon the submitted search query and wherein the displaying step (C) further comprises displaying the name of each of one or more suggested vertical collections.

40. The computer program product of claim 20, wherein the plurality of search results comprises a name of each of one or more suggested vertical collections, wherein the one or more suggested vertical suggestions are determined based upon the submitted search query and wherein the instructions for displaying (C) further comprise instructions for displaying the name of each of one or more suggested vertical collections.

41. The computer of claim 22, wherein the plurality of search results comprises a name of each of one or more suggested vertical collections, wherein the one or more suggested vertical suggestions are determined based upon the submitted search query and wherein the instructions for displaying (C) further comprise instructions for displaying the name of each of one or more suggested vertical collections.

42. The method of claim 1, the method further comprising, responsive to a selection and drag on the first annotated static graphic representation in the direction of a predetermined position on the graphic output device, storing a copy of the annotated static graphic representation corresponding to the annotated static graphic representation on a client device.
